(19) United States
(12) Patent Application Publication
(10) Pub. No.: US 2026/0225373 A1
(43) Pub. Date: Aug. 6, 2026

(54) INKJET PRINTER

(71) Applicant: MIMAKI ENGINEERING CO., LTD., Nagano (JP)

(72) Inventors: Soichiro Takehana, Nagano (JP); Katsutoshi Yamabe, Nagano (JP)

(73) Assignee: MIMAKI ENGINEERING CO., LTD., Nagano (JP)

(21) Appl. No.: 19/458,903

(22) Filed: Jan. 25, 2026

(30) Foreign Application Priority Data
Feb. 6, 2025 (JP) 2025-018324

(51) Int. Cl. B41J 2/175; B41J 25/00; B41J 29/02

(52) U.S. Cl. CPC B41J 2/17596; B41J 25/005; B41J 29/02

(57) ABSTRACT

An inkjet printer includes a head unit having an inkjet head that discharges ink; a carriage to which the head unit is detachably attached; a carriage drive mechanism that reciprocally moves the carriage in a main scanning direction orthogonal to an up-down direction; and an ink tank that contains ink supplied to the inkjet head. The head unit includes a plurality of ink inflow parts in which ink inlets are formed. The carriage includes a connection part that is connected to the ink tank and in which ink outlets are formed, and that is connectable to the plurality of ink inflow parts. A plurality of the outlets are formed in the connection part. The connection part includes a check valve that prevents ink leakage from each of the plurality of outlets in the case of the ink inflow parts and the connection part being separated from each other.

### CROSS-REFERENCE TO RELATED APPLICATION

This application claims the priority benefits of Japanese application no. 2025-018324, filed on Feb. 6, 2025. The entirety of the above-mentioned patent application is hereby incorporated by reference herein and made a part of this specification.

### BACKGROUND

### Technical Field

The disclosure relates to an inkjet printer.

### Related Art

Conventionally, commercial inkjet printers that perform printing on printing medium are known (for example, see Patent Document 1). The inkjet printer described in Patent Document 1 includes an inkjet head that discharges ink, a carriage on which the inkjet head is mounted, a carriage drive mechanism that moves the carriage in a main scanning direction, and an ink tank that contains ink supplied to the inkjet head.

Further, the inkjet printer described in Patent Document 1 includes a pressure adjustment mechanism for adjusting the internal pressure of the inkjet head, and an ink heating mechanism for warming the ink supplied to the inkjet head. Ink is supplied to the pressure adjustment mechanism from the ink tank. The ink heating mechanism is disposed between the pressure adjustment mechanism and the inkjet head in the supply path of ink to the inkjet head. The pressure adjustment mechanism and the ink heating mechanism are mounted on the carriage.

### Citation List

### Patent Document

Patent Document 1 Japanese Patent Application Laid-Open Publication No. 2021-94813

In the inkjet printer described in Patent Document 1, the inkjet head is replaced when the inkjet head deteriorates. If replacement operation of the inkjet head is complicated, it becomes difficult for a person without specialized knowledge of inkjet printers to perform the replacement operation. Therefore, it is preferable for the replacement operation of the inkjet head to be easy.

Therefore, an object of the disclosure is to provide an inkjet printer that enables easy replacement operation of an inkjet head.

### SUMMARY

The inkjet printer of the disclosure includes a head unit having an inkjet head that discharges ink; a carriage to which the head unit is detachably attached; a carriage drive mechanism that reciprocally moves the carriage in a main scanning direction orthogonal to an up-down direction; and an ink tank that contains ink supplied to the inkjet head. The head unit includes a plurality of ink inflow parts in which ink inlets are formed. The carriage includes a connection part that is connected to the ink tank and in which ink outlets are formed, and that is connectable to the plurality of ink inflow parts. A plurality of the outlets are formed in the connection part. The connection part includes a check valve that prevents ink leakage from each of the plurality of outlets when the ink inflow part and the connection part are separated from each other.

### BRIEF DESCRIPTION OF THE DRAWINGS

FIG. 1 is a perspective view of the inkjet printer according to an embodiment of the disclosure.

FIG. 2 is a schematic view illustrating a configuration of the inkjet printer shown in FIG. 1.

FIG. 3 is a perspective view of the head unit and the carriage shown in FIG. 2.

FIG. 4 is a perspective view of the head unit and the carriage shown in FIG. 3, in a state where the opening-closing unit and the main body side cover are open.

FIG. 5 is a side view of the head unit and the carriage shown in FIG. 3.

FIG. 6 is a plan view in which the main body side cover and unit side cover have been removed from the head unit and the carriage shown in FIG. 3.

FIG. 7 is a front view of the carriage shown in FIG. 4.

FIG. 8 is a side view of the carriage shown in FIG. 4.

FIG. 9 is a plan view of the carriage shown in FIG. 4.

FIG. 10 is a front view of the head unit shown in FIG. 4.

FIG. 11 is a plan view of the head unit shown in FIG. 4.

FIG. 12 is an enlarged view of part E in FIG. 4.

FIG. 13 is an enlarged side view illustrating the connection part and unit frame from the F-F direction in FIG. 7.

FIG. 14 is a cross-sectional view illustrating a state before the ink inflow part and the connection part shown in FIG. 11 are connected.

FIG. 15 is a cross-sectional view illustrating a state before the ink inflow part and the connection part shown in FIG. 11 are connected.

FIG. 16 is a cross-sectional view illustrating a state in which the ink inflow part and the connection part shown in FIG. 11 are connected.

FIG. 17 is an enlarged front view illustrating a connecting portion between the head side connector and the carriage side connector from the G-G direction in FIG. 6.

FIG. 18A and FIG. 18B are enlarged cross-sectional views of the fixture shown in FIG. 3.

### DESCRIPTION OF THE EMBODIMENTS

In the inkjet printer of the disclosure, the carriage includes a connection part in which a plurality of ink outlets are formed and that is connectable to the plurality of ink inflow parts of the head unit. Therefore, in the disclosure, when removing the inkjet head attached to the carriage together with the head unit, it is possible to separate the plurality of ink inflow parts and the connection part at once. Further, in the disclosure, when attaching the inkjet head together with the head unit to the carriage, it is possible to connect the plurality of ink inflow parts and the connection part at once. That is, in the disclosure, during replacement of the inkjet head, it is possible to connect or separate the plurality of ink inflow parts on the head unit side and the connection part on the carriage side at once. Therefore, in the disclosure, it is possible to easily perform replacement operation of the inkjet head.

Further, in the disclosure, the connection part includes a check valve that prevents ink leakage from each of the plurality of outlets when the ink inflow part and the connection part are separated. Therefore, in the disclosure, when removing the inkjet head attached to the carriage together with the head unit, it is possible to prevent ink remaining in the connection part from leaking from the outlets. Therefore, in the disclosure, it is possible to perform replacement operation of the inkjet head without concern about ink leakage from the outlets. As a result, in the disclosure, it is possible to perform replacement operation of the inkjet head more easily.

In the disclosure, for example, the ink inflow part is formed in a tubular shape and is inserted into the outlet, a connection part ink flow path, which is an ink flow path leading to the outlet, is formed in the connection part, the connection part includes an annular seal member that comes into contact with an outer peripheral surface of the ink inflow part inserted into the outlet with a predetermined contact pressure, and the check valve includes a sphere disposed in the connection part ink flow path and a spring member that biases the sphere toward the seal member. In this case, it is possible to prevent ink remaining in the connection part from leaking from the outlet with a relatively simple configuration.

In the disclosure, it is preferable that the carriage includes a carriage main body on which the head unit is mounted and an opening-closing unit rotatably attached to the carriage main body, and the opening-closing unit includes the connection part and is rotatable relative to the carriage main body between a close position where all of the ink inflow parts and the connection part are connected to enable ink inflow from the connection part to all of the ink inflow parts, and an open position where all of the ink inflow parts and the connection part are separated to disable ink inflow from the connection part to all of the ink inflow parts.

With this configuration, when removing the inkjet head attached to the carriage together with the head unit, by rotating the opening-closing unit disposed at the close position to the open position, it is possible to separate the ink inflow part and the connection part so that ink inflow from the connection part to the ink inflow part becomes impossible. Further, when attaching the inkjet head together with the head unit to the carriage, by rotating the opening-closing unit to the close position in a state where the head unit is mounted on the carriage main body, it is possible to connect the ink inflow part and the connection part so that ink inflow from the connection part to the ink inflow part becomes possible. That is, merely by rotating the opening-closing unit during replacement of the inkjet head, it is possible to connect or separate the ink path on the carriage side and the ink path on the head unit side. Therefore, it is possible to perform replacement operation of the inkjet head more easily.

In the disclosure, it is preferable that the opening-closing unit is attached to an upper end of the carriage main body and is rotatable relative to the carriage main body with a horizontal direction as an axial direction of rotation, and the connection part is connected to the ink inflow part from an upper side. With this configuration, a person performing replacement operation of the inkjet head can rotate the opening-closing unit relative to the carriage main body on an upper side of the carriage. Therefore, it is possible to easily perform rotation operation of the opening-closing unit relative to the carriage main body.

In the disclosure, for example, the ink inflow part is formed in a tubular shape with the up-down direction as the axial direction, one of the inlets is formed at an upper end of the ink inflow part, and all of the ink inflow parts are inserted into the outlets in response to the opening-closing unit being disposed at the close position.

In the disclosure, it is preferable that the opening-closing unit includes a unit frame that rotatably holds the connection part, the unit frame is rotatably attached to the carriage main body, and in response to the axial direction of rotation of the unit frame relative to the carriage main body being taken as a first direction, the connection part is rotatable relative to the unit frame with the first direction as the axial direction of rotation. With this configuration, even in the case of inserting a plurality of ink inflow parts into outlets of the connection part by rotating the opening-closing unit relative to the carriage main body, it is possible to rotate the connection part relative to the unit frame and orient the connection part in a direction that facilitates insertion of the ink inflow parts into the outlets. Therefore, it is possible to easily perform connection between the ink inflow parts and the connection part.

In the disclosure, it is preferable that the unit frame includes a regulating component for regulating a rotation range of the connection part relative to the unit frame. The connection part includes a shaft part that constitutes an end of the connection part in the first direction, and a regulation protrusion that protrudes from the shaft part toward a radially outer side of the shaft part. The regulating component is formed with an insertion port into which the shaft part is inserted, and a regulation concave part in which the regulation protrusion is disposed. The rotation range of the connection part relative to the unit frame is regulated by the regulation protrusion and the regulation concave part. With this configuration, even in the case of the connection part being rotatable relative to the unit frame, it is possible to prevent the connection part from excessively rotating relative to the unit frame.

As described above, in the inkjet printer of the disclosure, it is possible to easily perform replacement operation of the inkjet head.

Hereinafter, embodiments of the disclosure will be described with reference to the drawings.

### Schematic Configuration of Inkjet Printer

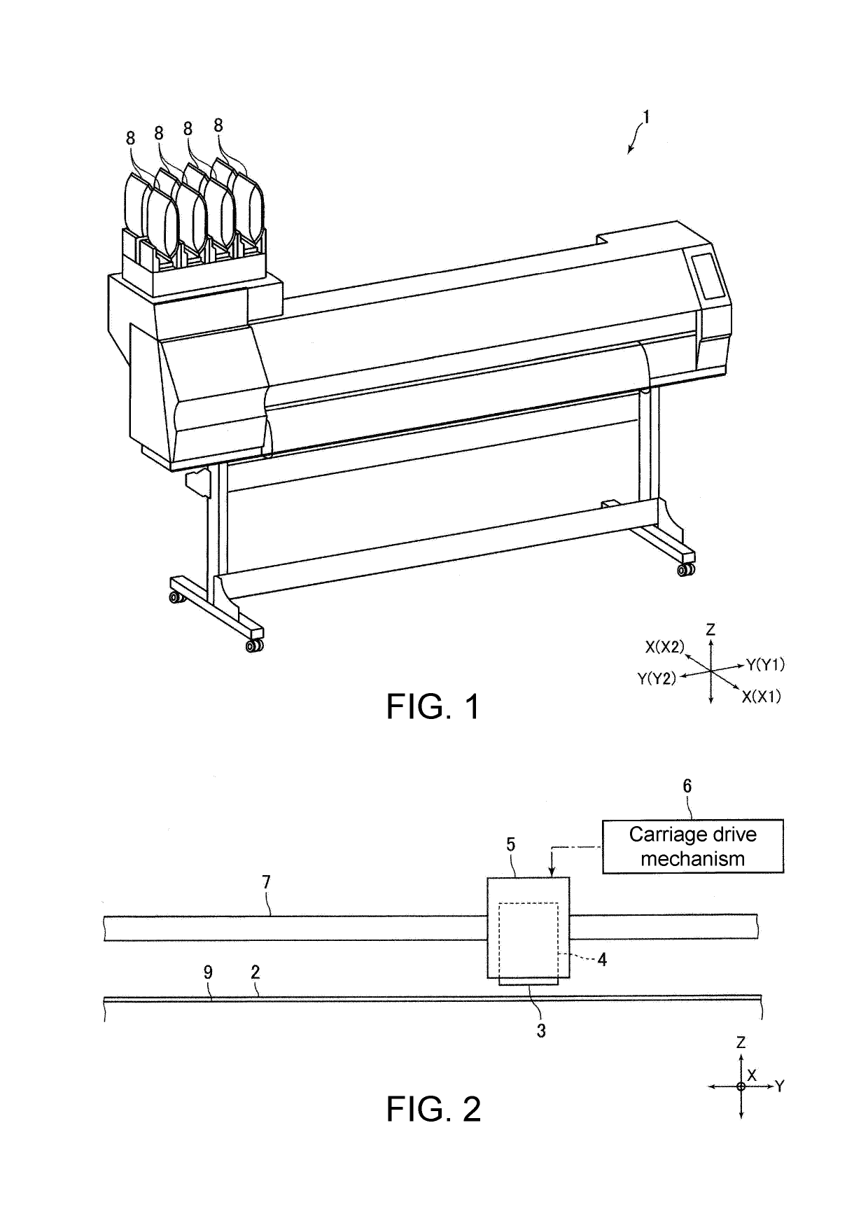

FIG. 1 is a perspective view of an inkjet printer 1 according to an embodiment of the disclosure. FIG. 2 is a schematic view illustrating the configuration of the inkjet printer 1 shown in FIG. 1.

The inkjet printer 1 of the present embodiment (hereinafter referred to as “printer 1”) is, for example, a commercial inkjet printer, and performs printing on printing medium 2. The printing medium 2 is, for example, printing paper, fabric, or a resin film or the like. The printer 1 includes a head unit 4 having an inkjet head 3 (hereinafter referred to as “head 3”) that discharges ink toward the printing medium 2, a carriage 5 to which the head unit 4 is detachably attached, a carriage drive mechanism 6 that reciprocally moves the carriage 5 in a main scanning direction (Y direction in FIG. 1 and the like) orthogonal to an up-down direction (vertical direction, Z direction in FIG. 1 and the like), a guide rail 7 for guiding the carriage 5 in the main scanning direction, and a plurality of ink tanks 8 that contain ink supplied to the head 3. Moreover, the printer 1 may include a guide shaft instead of the guide rail 7.

The head 3 discharges ink downward. A nozzle surface (ink discharge surface) on which a plurality of nozzles are arranged is formed on the lower surface of the head 3. The head 3 includes a piezoelectric actuator (piezo actuator) that discharges ink from the nozzles. A platen 9 is disposed below the head 3. The printing medium 2 during printing is placed on the platen 9. The carriage drive mechanism 6 includes, for example, two pulleys, a belt that is stretched over the two pulleys and is partially fixed to the carriage 5, and a motor that rotates the pulleys. The printer 1 also includes a medium transport mechanism that transports the printing medium 2 in a sub-scanning direction orthogonal to the main scanning direction.

In the following description, the main scanning direction (Y direction) is referred to as the “left-right direction”, and the direction orthogonal to the up-down direction (Z direction) and the main scanning direction (X direction in FIG. 1 and the like) is referred to as the “front-rear direction” Moreover, the Y1 direction side in FIG. 1 and the like, which is one side in the left-right direction, is referred to as the “right” side, the Y2 direction side in FIG. 1 and the like, which is the opposite side of the right side, is referred to as the “left” side, the X1 direction side in FIG. 1 and the like, which is one side in the front-rear direction, is referred to as the “front” side, and the X2 direction side in FIG. 1 and the like, which is the opposite side of the front side, is referred to as the “rear” side.

### Schematic Configuration of Carriage

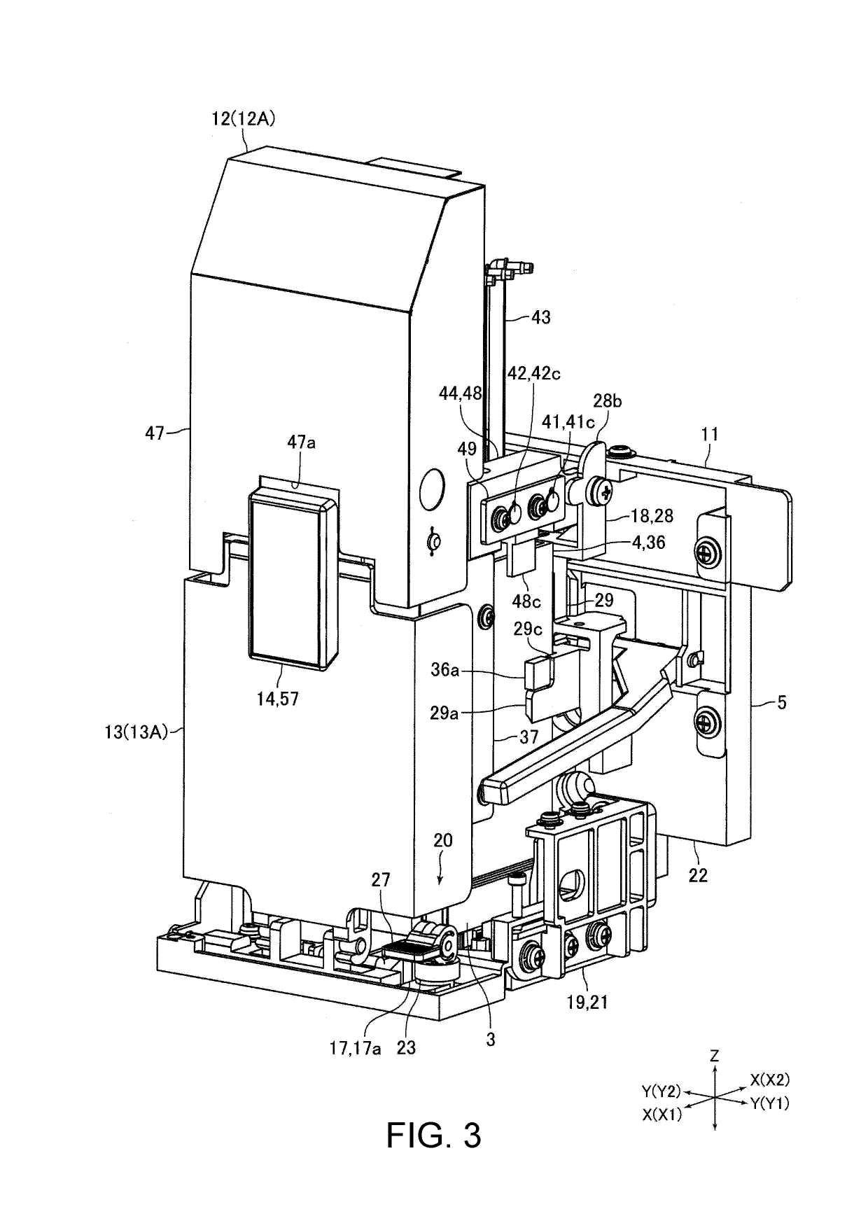

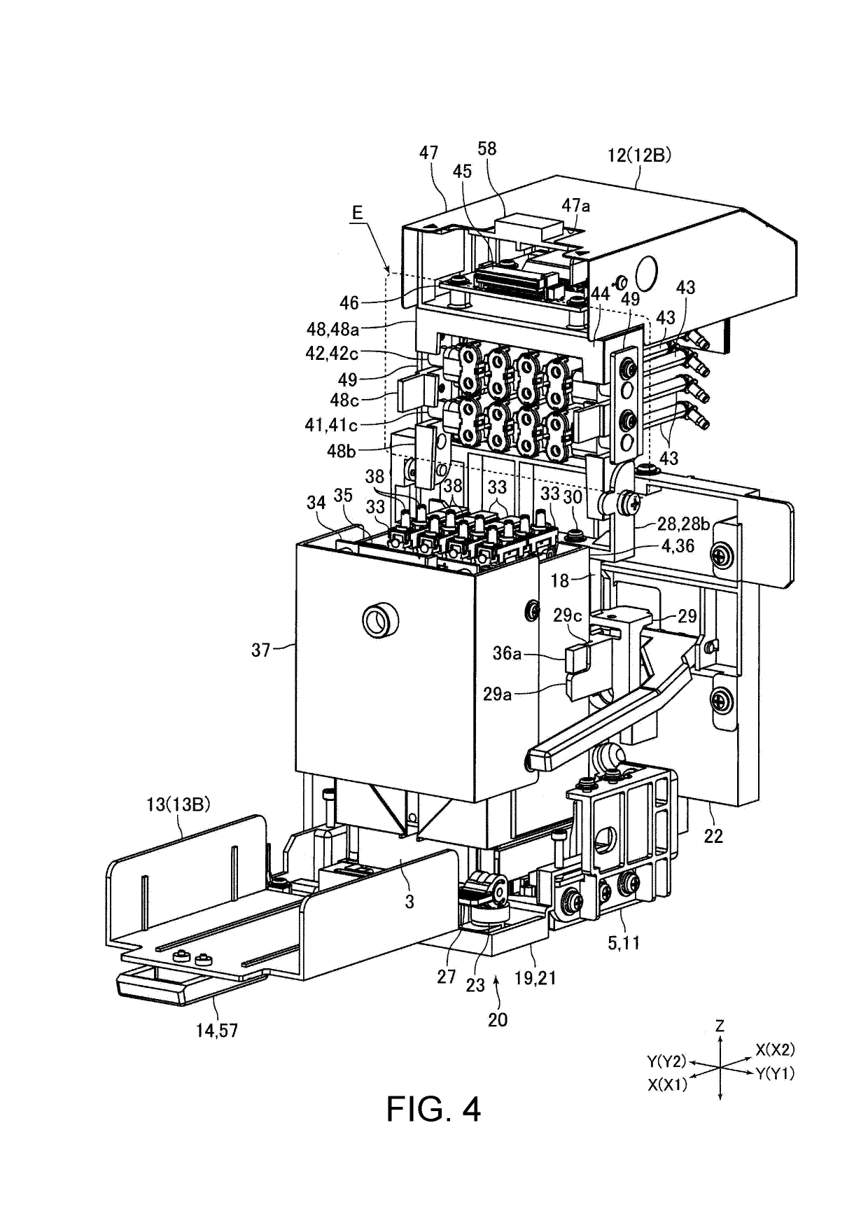

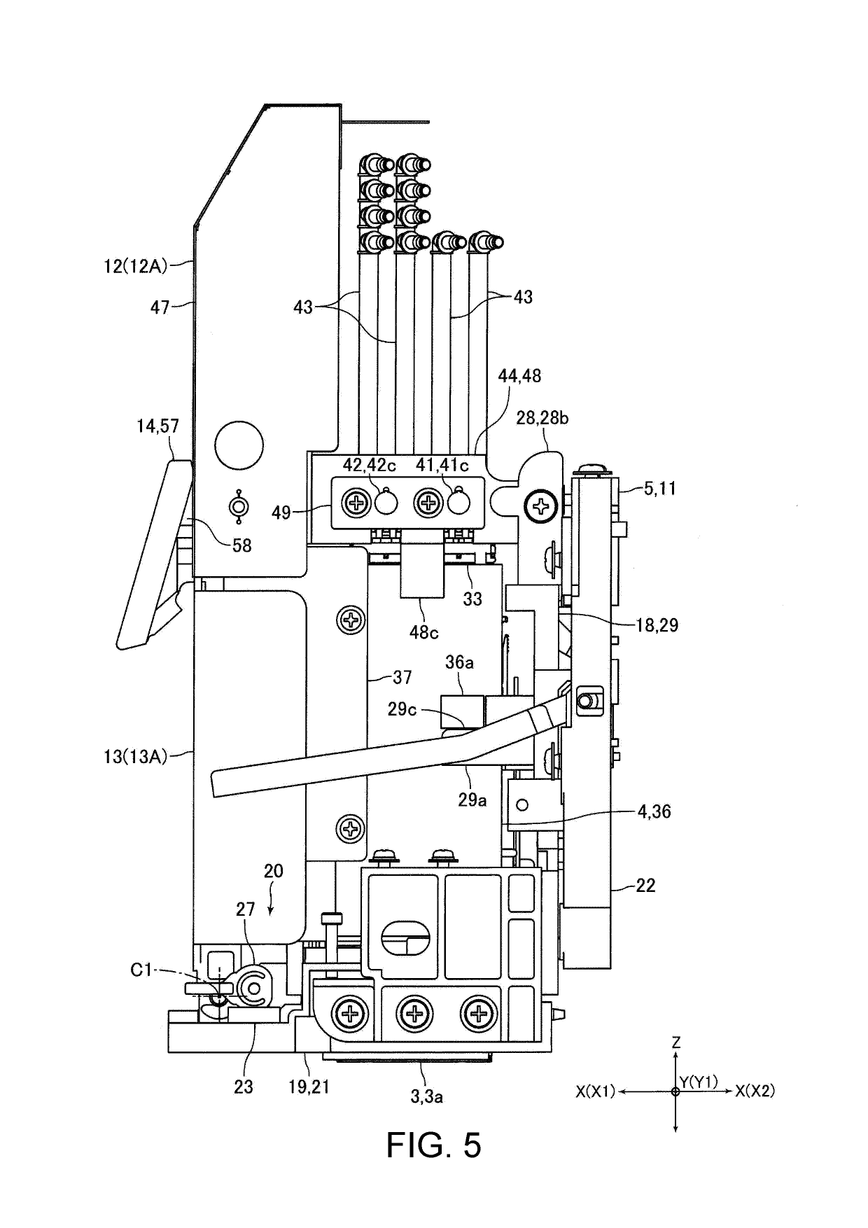

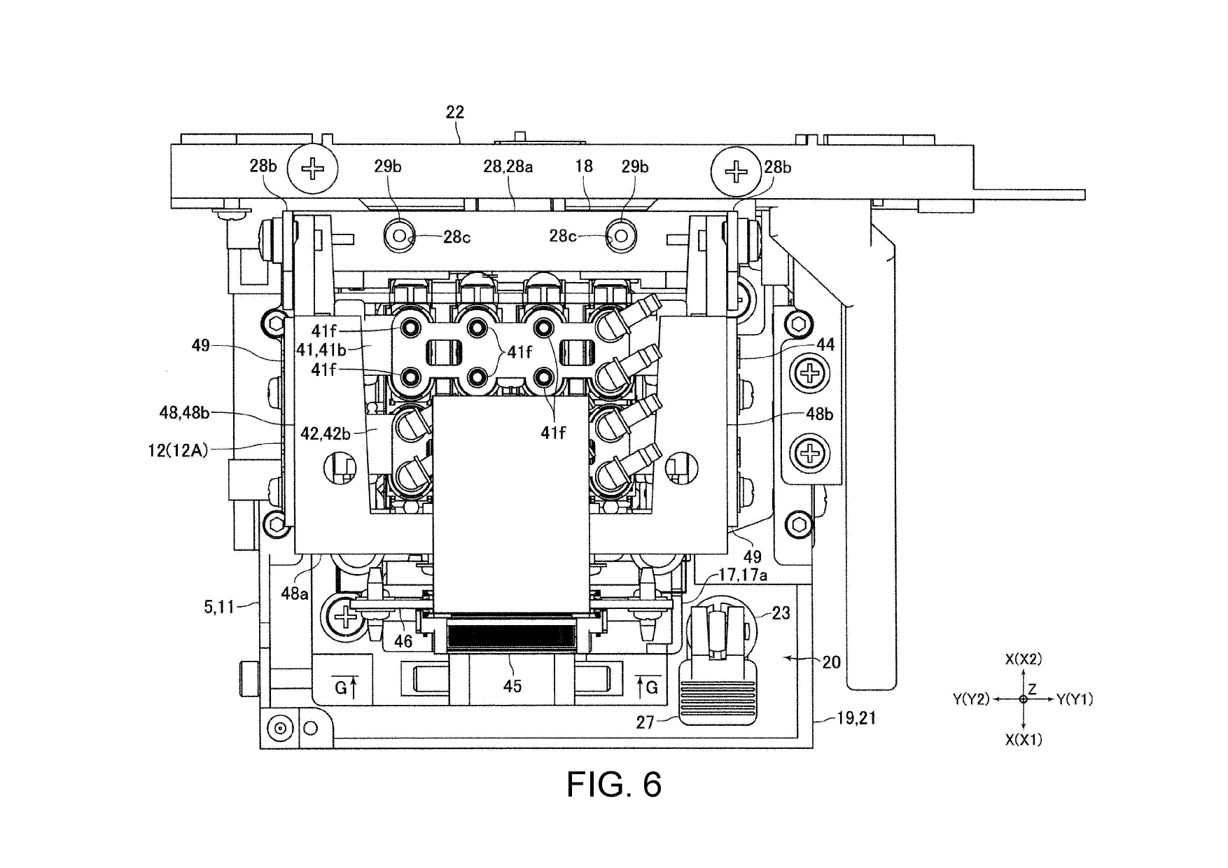

FIG. 3 is a perspective view of the head unit 4 and the carriage 5 shown in FIG. 2. FIG. 4 is a perspective view of the head unit 4 and the carriage 5 shown in FIG. 3 in a state where an opening-closing unit 12 and a main body side cover 13 are open. FIG. 5 is a side view of the head unit 4 and the carriage 5 shown in FIG. 3. FIG. 6 is a plan view in which the main body side cover 13 and unit side covers 37, 47 have been removed from the head unit 4 and the carriage 5 shown in FIG. 3.

The carriage 5 includes a carriage main body 11 on which the head unit 4 is mounted, an opening-closing unit 12 rotatably attached to the carriage main body 11, a main body side cover 13 rotatably attached to the carriage main body 11, and a fixture 14 for fixing the opening-closing unit 12 and the main body side cover 13 to each other. The head unit 4 is mounted on the carriage main body 11 from the upper side.

The opening-closing unit 12 is attached to an upper end of the carriage main body 11. Moreover, the opening-closing unit 12 is connected to a rear upper end of the carriage main body 11. The opening-closing unit 12 is rotatable relative to the carriage main body 11 with the horizontal direction as the axial direction of rotation. Specifically, the opening-closing unit 12 is rotatable relative to the carriage main body 11 with the left-right direction, which is the main scanning direction, as the axial direction of rotation. The opening-closing unit 12 is rotatable relative to the carriage main body 11 with the rear upper end of the carriage main body 11 as the rotational center. The opening-closing unit 12 is disposed above the head unit 4 mounted on the carriage main body 11.

The main body side cover 13 is attached to a lower end portion of the carriage main body 11. Specifically, the main body side cover 13 is connected to a front lower end portion of the carriage main body 11. More specifically, the main body side cover 13 is connected to a front end portion of a head unit mounting part 17, which will be described later, that constitutes a part of the carriage main body 11. The main body side cover 13 is rotatable relative to the carriage main body 11 with the left-right direction as the axial direction of rotation. Moreover, the main body side cover 13 is rotatable relative to the carriage main body 11 with the front lower end portion (lower end portion on the front side) of the carriage main body 11 as the rotational center.

The main body side cover 13 is rotatable relative to the carriage main body 11 between a standing position 13A (see FIG. 3) that covers the head unit 4 mounted on the carriage main body 11 from the front side, and an opening position 13B (see FIG. 4) that falls forward from the standing position 13A. That is, the main body side cover 13 is rotatable relative to the carriage main body 11 between the opening position 13B that opens the front side of the head unit 4, and a standing position 13A that stands up from the opening position 13B. The carriage 5 includes a sensor for detecting that the main body side cover 13 is disposed at the standing position 13A.

### Configuration of Carriage main body

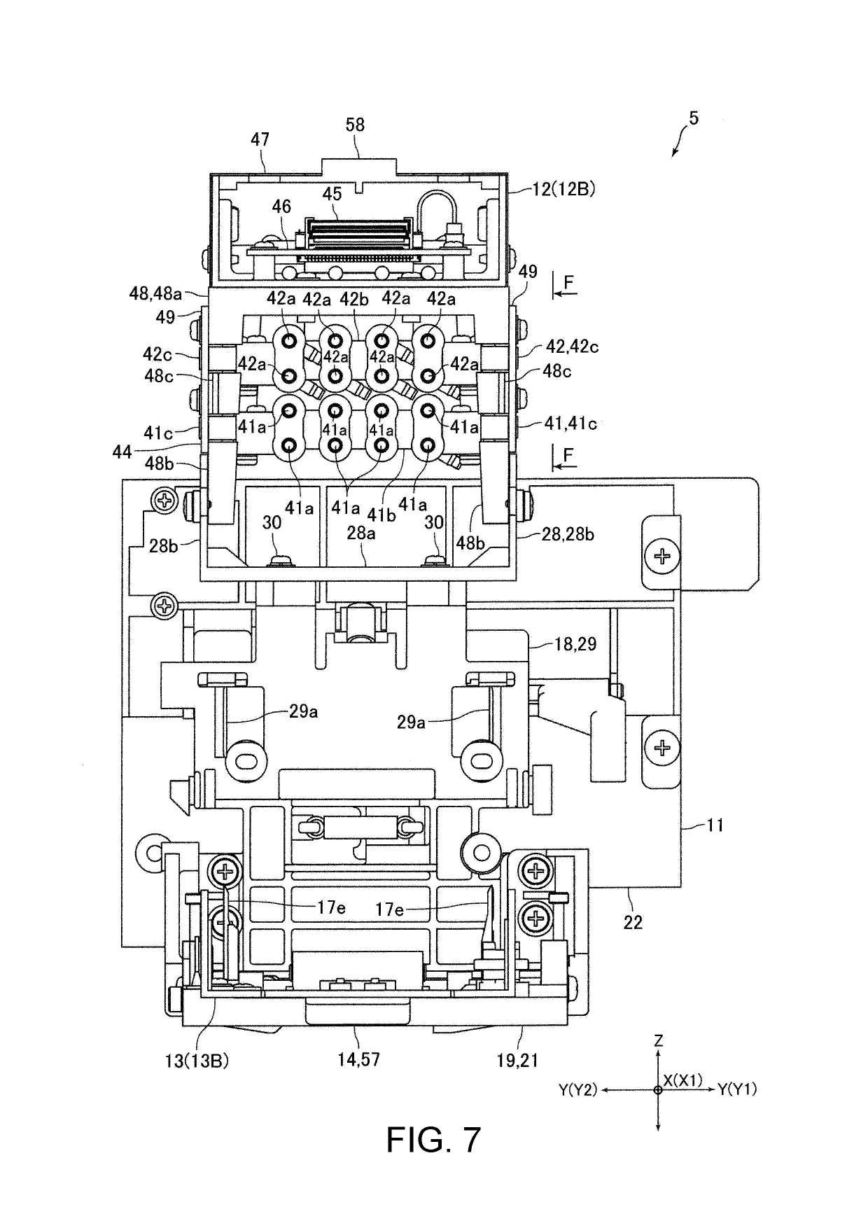

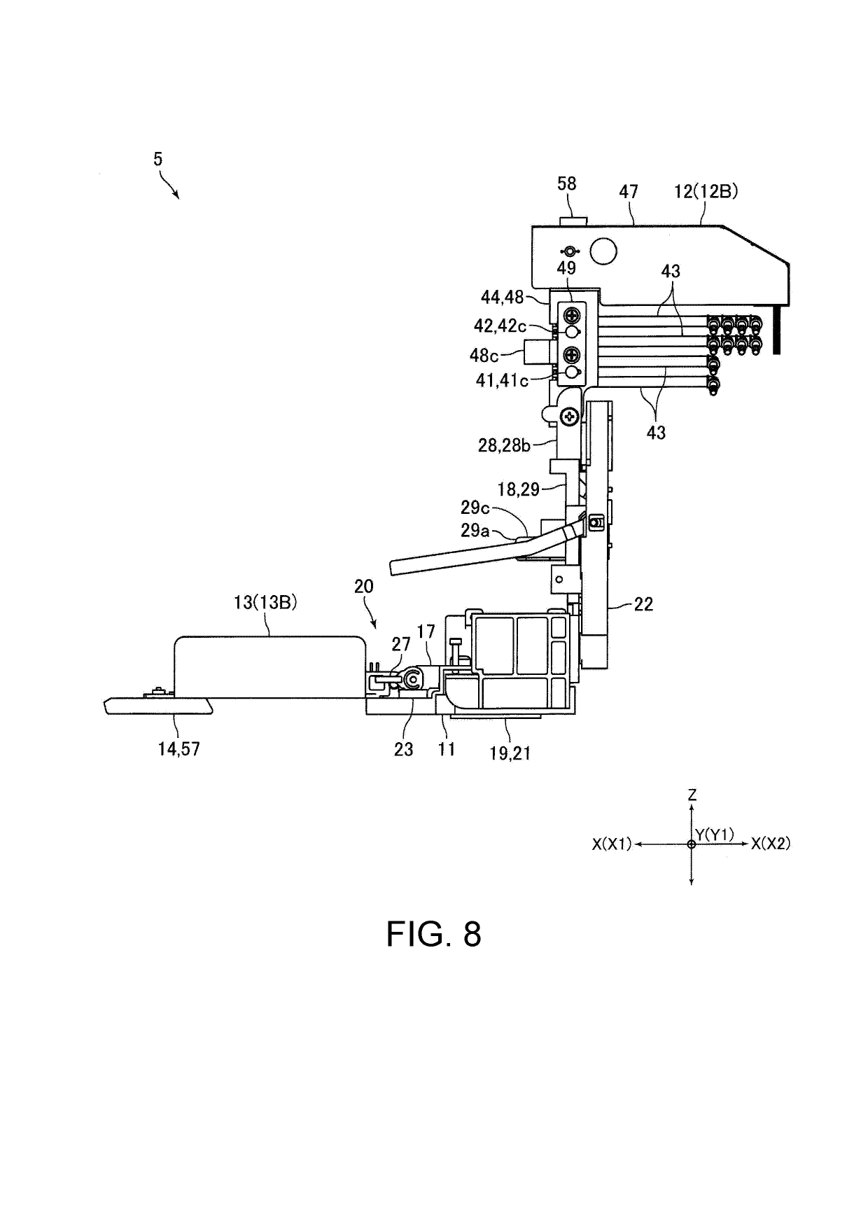

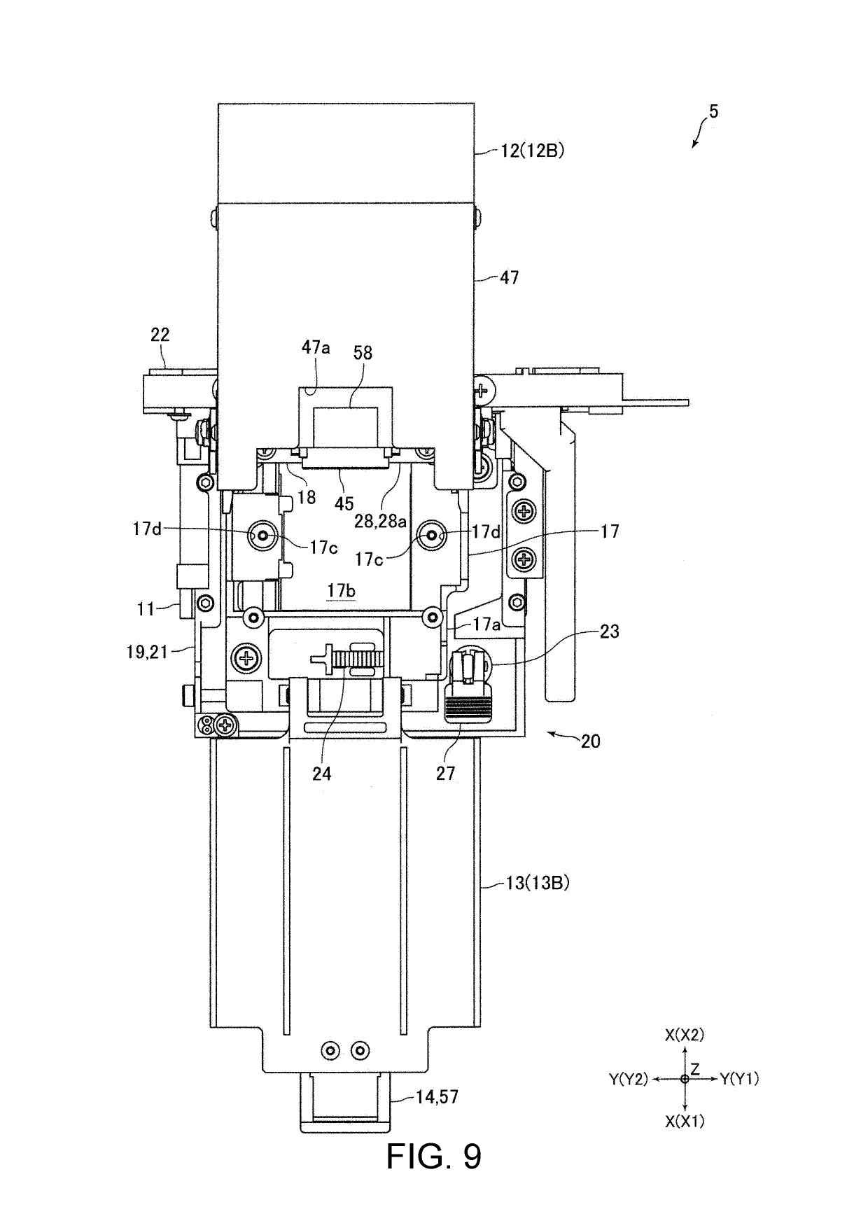

FIG. 7 is a front view of the carriage 5 shown in FIG. 4. FIG. 8 is a side view of the carriage 5 shown in FIG. 4. FIG. 9 is a plan view of the carriage 5 shown in FIG. 4.

The carriage main body 11 includes a head unit mounting part 17 on which the head unit 4 is mounted, an opening-closing unit retaining part 18 to which the opening-closing unit 12 is attached, a carriage base 19 to which the head unit mounting part 17 and the opening-closing unit retaining part 18 are attached, and a tilt adjustment mechanism 20 for adjusting the tilt of the head 3 relative to the carriage base 19 in a rotation direction with the up-down direction as the axial direction of rotation.

The carriage base 19 includes a carriage bottom part 21 that constitutes a lower end portion of the carriage 5, and a carriage back part 22 that constitutes a rear portion of the carriage 5. The head unit mounting part 17 is mounted on the carriage bottom part 21. The head unit mounting part 17 is fixed to the carriage bottom part 21. In response to the fixed state of the head unit mounting part 17 to the carriage bottom part 21 being released, the head unit mounting part 17 becomes rotatable relative to the carriage bottom part 21 in a rotation direction with the up-down direction as the axial direction of rotation. An opening that penetrates the carriage bottom part 21 in the up-down direction is formed in the carriage bottom part 21. In this opening, an ink discharge part 3a, which will be described later, is formed at a lower end portion of the head 3, is disposed. The carriage back part 22 extends upward from a rear end of the carriage bottom part 21.

As described above, the head unit 4 is mounted on the head unit mounting part 17. In the present embodiment, the tilt adjustment mechanism 20 adjusts the tilt of the head unit mounting part 17 relative to the carriage bottom part 21 in a rotation direction with the up-down direction as the axial direction of rotation, thereby adjusting the tilt of the head 3 relative to the carriage base 19. The tilt adjustment mechanism 20 includes an eccentric cam 23 for adjusting the tilt of the head unit mounting part 17 relative to the carriage bottom part 21, and a compression coil spring 24 (see FIG. 9) that biases the head unit mounting part 17 toward one side in a rotation direction with the up-down direction as the axial direction of rotation.

The head unit mounting part 17 includes a contact part 17a with which the eccentric cam 23 and the compression coil spring 24 come into contact. The contact part 17a is disposed at a right front end portion of the head unit mounting part 17. The contact part 17a protrudes toward the front side. An opening 17b that penetrates the head unit mounting part 17 in the up-down direction is formed in the head unit mounting part 17 (see FIG. 9). The opening 17b is formed in a center portion of the head unit mounting part 17. In the opening 17b, an ink discharge part 3a, which will be described later, is formed at a lower end portion of the head 3, is disposed.

The head unit mounting part 17 includes a carriage side positioning part 17c for positioning the head unit 4 relative to the carriage main body 11 in a horizontal direction (see FIG. 9). The carriage side positioning part 17c is a columnar convex part that protrudes toward the upper side from the bottom of the head unit mounting part 17. Therefore, hereinafter, the carriage side positioning part 17c is described as “convex part 17c”. The convex part 17c is formed at two locations on both sides of the opening 17b in the left-right direction. The convex part 17c is formed in a round hole-shaped hole 17d that is recessed downward from an upper surface of the head unit mounting part 17. The convex part 17c extends upward from the center of a bottom surface of the hole 17d.

Further, the head unit mounting part 17 includes two guide parts 17e for guiding the head unit 4 mounted on the carriage main body 11 to a predetermined mounting position (see FIG. 7). The two guide parts 17e are formed on an outer side in the left-right direction relative to the two holes 17d. The guide part 17e is a flat plate-shaped wall that protrudes toward the upper side from the bottom of the head unit mounting part 17. The guide part 17e guides the head unit 4 to a predetermined mounting position in the left-right direction.

The eccentric cam 23 is disposed on an upper surface side of the carriage bottom part 21. The eccentric cam 23 is fixed to a cam lever 27. The cam lever 27 is attached to the carriage bottom part 21 so as to be rotatable relative to the carriage bottom part 21 in a rotation direction with the up-down direction as an axial direction of rotation. The eccentric cam 23 and the cam lever 27 are attached to a right front end portion of the carriage bottom part 21. An outer peripheral surface (cam surface) of the eccentric cam 23 is in contact with a right side surface of the contact part 17a of the head unit mounting part 17. A lever part of the cam lever 27 is disposed on an upper side of the eccentric cam 23. In response to this lever part being tilted down, the eccentric cam 23 is fixed so that the eccentric cam 23 does not rotate relative to the carriage bottom part 21. On the other hand, in response to the lever part being raised up, it is possible to rotate the eccentric cam 23 relative to the carriage bottom part 21.

At a rear end of the carriage bottom part 21, a fulcrum part that serves as a rotational center of the head unit mounting part 17 relative to the carriage bottom part 21 is disposed. This fulcrum part is disposed at a center portion of the carriage bottom part 21 in the left-right direction. The compression coil spring 24 is disposed at a front portion of the carriage bottom part 21. A left end of the compression coil spring 24 abuts against a spring abutment part formed on the carriage bottom part 21, and a right end of the compression coil spring 24 is in contact with a left side surface of the contact part 17a of the head unit mounting part 17. The compression coil spring 24 biases the head unit mounting part 17 toward the eccentric cam 23 with the fulcrum part as a fulcrum.

When adjusting the tilt of the head unit mounting part 17 relative to the carriage bottom part 21 by the tilt adjustment mechanism 20, after releasing the fixed state of the head unit mounting part 17 to the carriage bottom part 21, the eccentric cam 23 is rotated. In response to the eccentric cam 23 being rotated, the head unit mounting part 17 rotates relative to the carriage bottom part 21, and the tilt of the head 3 relative to the carriage base 19 is adjusted. In response to the tilt of the head 3 relative to the carriage base 19 being adjusted, the head unit mounting part 17 is fixed to the carriage bottom part 21.

The opening-closing unit retaining part 18 includes a holding member 28 to which the opening-closing unit 12 is rotatably attached, and a connection member 29 to which the holding member 28 is fixed and which is fixed to the head unit mounting part 17. The connection member 29 is fixed to a rear end of the head unit mounting part 17. The connection member 29 extends upward from the rear end of the head unit mounting part 17. The connection member 29 is disposed on the front side of the carriage back part 22.

The connection member 29 includes two guide parts 29a for guiding the head unit 4 mounted on the carriage main body 11 to a predetermined mounting position. The guide parts 29a are formed above the guide parts 17e. The guide parts 29a are flat plate-shaped walls that protrude toward the front side, and guide the head unit 4 to the predetermined mounting position in the left-right direction. A notch part 29c is formed in the guide part 29a disposed on the right side among the two guide parts 29a. The notch part 29c is formed in a front side and upper portion of the guide part 29a. The notch part 29c may be formed in the guide part 29a disposed on the left side.

An upper end surface of the connection member 29 is a plane orthogonal to the up-down direction. The upper end surface of the connection member 29 is a fixing surface to which the holding member 28 is fixed. A positioning protrusion 29b for positioning the holding member 28 in the left-right direction is formed on the upper end surface of the connection member 29 (see FIG. 6). The positioning protrusion 29b is formed in a cylindrical shape that protrudes toward the upper side. A screw hole is formed on an inner peripheral surface of the positioning protrusion 29b.

The holding member 28 is configured by a fixed part 28a that is fixed to the connection member 29, and two support units 28b that support the opening-closing unit 12. The fixed part 28a is formed in a rectangular flat plate shape that is elongated in the left-right direction. The thickness direction of the fixed part 28a coincides with the up-down direction. The support units 28b extend upward from both ends of the fixed part 28a in the left-right direction. The support units 28b are formed in a flat plate shape with the left-right direction as the thickness direction. The fixed part 28a is mounted on the upper end surface of the connection member 29. A through hole 28c in which the positioning protrusion 29b is disposed is formed in the fixed part 28a (see FIG. 6). The through hole 28c is an elongated hole with the front-rear direction as a long-side direction. The fixed part 28a is fixed to the connection member 29 by a screw 30 that engages with a screw hole on the inner peripheral surface of the positioning protrusion 29b.

### Configuration of Head Unit

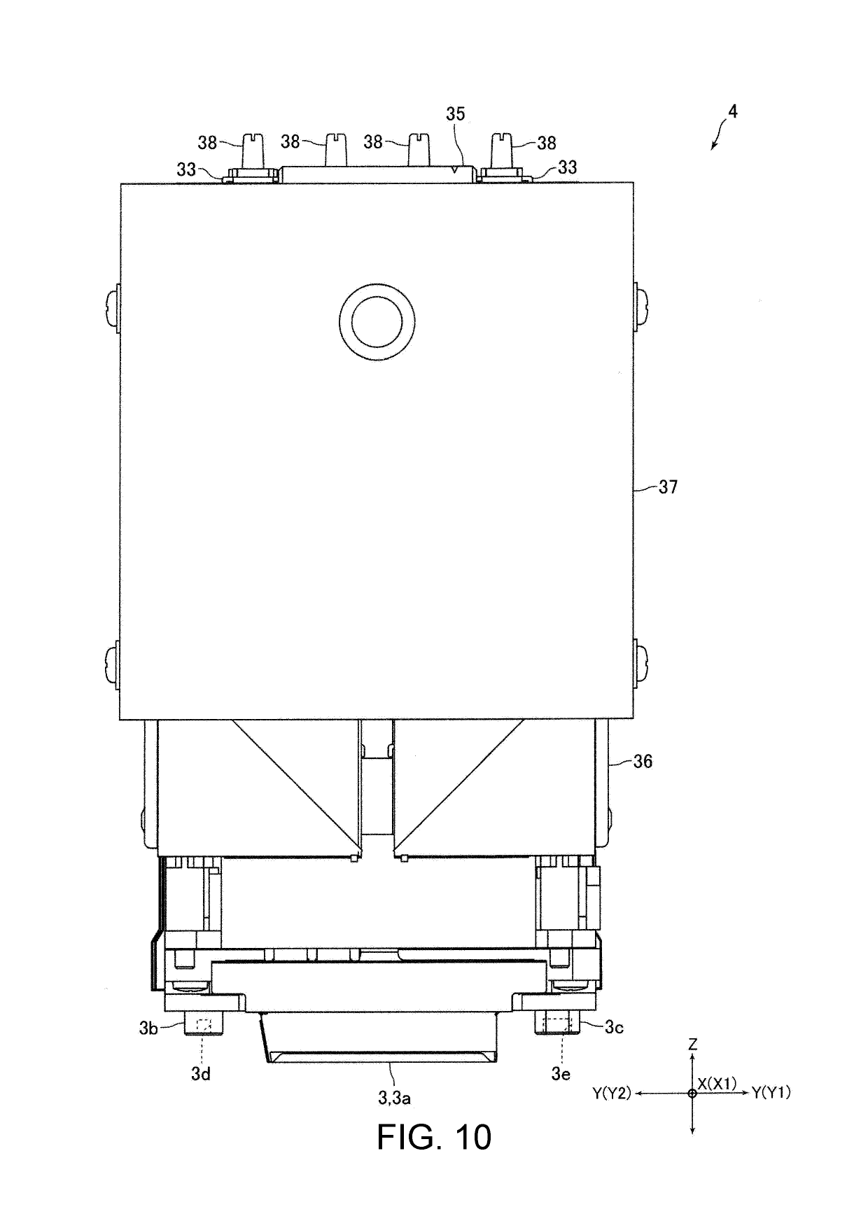

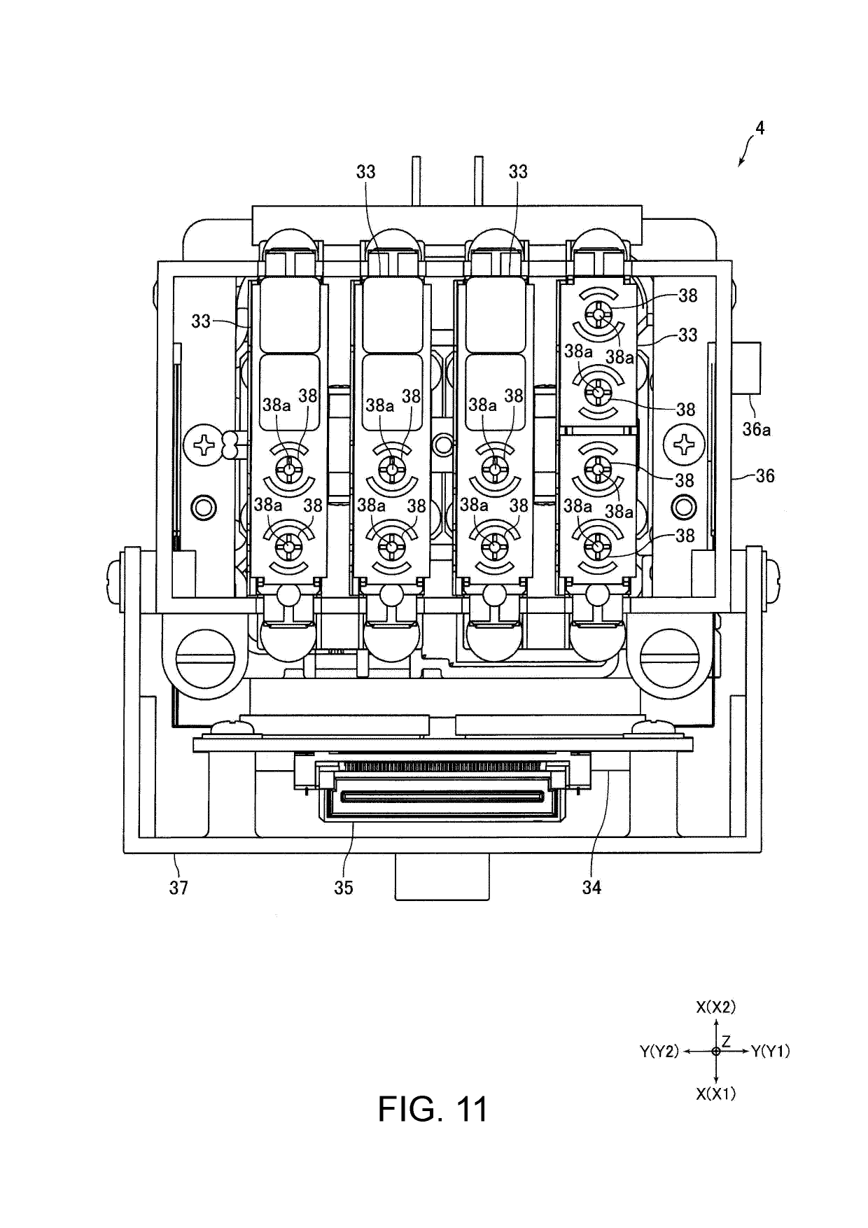

FIG. 10 is a front view of the head unit 4 shown in FIG. 4. FIG. 11 is a plan view of the head unit 4 shown in FIG. 4.

The head unit 4 includes, in addition to the head 3, a pressure adjustment mechanism 33 for adjusting pressure of ink supplied to the head 3, a circuit board 34 to which the head 3 is electrically connected, a connector 35 mounted on the circuit board 34, a unit frame 36 to which these components are attached, and an unit side cover 37 that covers the circuit board 34. Moreover, the head unit 4 of the present embodiment includes, for example, one head 3. Moreover, the head unit 4 of the present embodiment includes, for example, four pressure adjustment mechanisms 33. Moreover, the head unit 4 of the present embodiment includes one circuit board 34. The circuit board 34 of the present embodiment is a head side circuit board, and the connector 35 is a head side connector.

The head unit 4 includes an ink heating mechanism that warms ink supplied to the head 3. The ink heating mechanism is disposed between the pressure adjustment mechanism 33 and the head 3 in a supply path of ink to the head 3. Moreover, the head unit 4 may not include the ink heating mechanism. The head unit 4 may include two or more heads 3, or may include three or fewer or five or more pressure adjustment mechanisms 33.

The left side surface of the unit frame 36 is a plane orthogonal to the left-right direction. On the right side surface of the unit frame 36, a rectangular parallelepiped-shaped convex part 36a that protrudes toward the right side is formed. A portion of the right side surface of the unit frame 36, excluding the convex part 36a, is a plane orthogonal to the left-right direction. The unit frame 36 is disposed between two guide parts 29a in the left-right direction. The convex part 36a is disposed in the notch part 29c of the guide part 29a. The convex part 36a and the notch part 29c serve as landmarks during mounting of the head unit 4 to the carriage main body 11. In the case where the notch part 29c is formed in the guide part 29a disposed on the left side, a rectangular parallelepiped-shaped convex part 36a that protrudes toward the left side is also formed on the left side surface of the unit frame 36.

The head 3 is fixed to the lower end portion of the unit frame 36 and constitutes the lower end portion of the head unit 4. As described above, a nozzle surface on which a plurality of nozzles are arranged is formed on the lower surface of the head 3. In the present embodiment, an ink discharge part 3a that protrudes downward is formed at the lower end portion of the head 3, and the lower surface of the ink discharge part 3a serves as the nozzle surface. The ink discharge part 3a is disposed within the opening of the carriage bottom part 21 and the opening 17b of the head unit mounting part 17.

Both sides of the ink discharge part 3a in the left-right direction are planes orthogonal to the up-down direction. As shown in FIG. 10, protrusion parts 3b and 3c that protrude downward are formed on both sides of the ink discharge part 3a in the left-right direction. In the present embodiment, the protrusion part 3b is disposed on the left side of the ink discharge part 3a, and the protrusion part 3c is disposed on the right side of the ink discharge part 3a. The protrusion part 3b is formed in a cylindrical shape with the up-down direction as the axial direction. The protrusion part 3c is formed in a substantially cylindrical shape with the up-down direction as the axial direction. The outer shape of the protrusion part 3c when viewed from the up-down direction is an oval shape that is long in the left-right direction.

The inner peripheral side of the protrusion part 3b serves as a concave part 3d with which the convex part 17c of the head unit mounting part 17 engages. The inner peripheral side of the protrusion part 3c serves as a concave part 3e with which the convex part 17c of the head unit mounting part 17 engages. In the present embodiment, the head 3 is positioned relative to the head unit mounting part 17 in the horizontal direction by the convex part 17c and the concave parts 3d and 3e. The concave parts 3d and 3e in the present embodiment are unit side positioning parts for positioning the head unit 4 relative to the carriage main body 11 in the horizontal direction by engaging with the convex part 17c that is a carriage side positioning part. That is, the head unit 4 includes the concave parts 3d and 3e that are unit side positioning parts.

The concave part 3d is a round hole having a circular shape when viewed from the up-down direction. The inner diameter of the concave part 3d is substantially equal to the outer diameter of the convex part 17c. The concave part 3e is an elongated hole having an oval shape when viewed from the up-down direction. Moreover, the concave part 3e is an elongated hole with the left-right direction as the long-side direction. The width of the concave part 3e in the short-side direction (width in the front-rear direction) is substantially equal to the outer diameter of the convex part 17c. The convex part 17c is inserted into the concave parts 3e and 3d. The protrusion parts 3b and 3c are inserted into the hole 17d.

The pressure adjustment mechanism 33 is, for example, a mechanical pressure damper configured similarly to the pressure adjustment mechanism disclosed in the above-mentioned Patent Document 1. Ink supplied to the head 3 is contained inside the pressure adjustment mechanism 33. Moreover, inside the pressure adjustment mechanism 33, an ink flow path through which ink flows is formed. The pressure adjustment mechanism 33 includes, for example, a thin film disposed so as to contact the ink flow path and a spring for biasing the thin film. The pressure adjustment mechanism 33 mechanically adjusts the pressure of ink supplied to the head 3 without using a pump for pressure adjustment. Moreover, the pressure adjustment mechanism 33 adjusts the pressure of ink supplied to the head 3 so that an ink chamber formed inside the head 3 has negative pressure.

Ink is supplied to the pressure adjustment mechanism 33 from the ink tank 8 via connection parts 41 and 42, which will be described later, that constitute a part of the opening-closing unit 12. Specifically, the ink tank 8 is disposed above the pressure adjustment mechanism 33, and ink is supplied from the ink tank 8 to the pressure adjustment mechanism 33 via the connection parts 41 and 42 by head difference. The pressure adjustment mechanism 33 is formed in a flat rectangular parallelepiped-shape with a thin thickness in the left-right direction. The four pressure adjustment mechanisms 33 are disposed on the upper side of the head 3. Moreover, the four pressure adjustment mechanisms 33 are arranged in the left-right direction.

The pressure adjustment mechanism 33 includes an ink inflow part 38 in which an inlet 38a for ink is formed. That is, the head unit 4 includes the ink inflow part 38. Ink flows into the pressure adjustment mechanism 33 from the inlet 38a. The ink inflow part 38 is formed in a tubular shape with the up-down direction as the axial direction. Moreover, the ink inflow part 38 is formed in a cylindrical shape. The inlet 38a is formed at the upper end of the ink inflow part 38, and one inlet 38a is formed in the ink inflow part 38. The ink inflow part 38 protrudes above the upper end of the unit frame 36 and the upper end of the unit side cover 37.

The pressure adjustment mechanism 33 includes a plurality of ink inflow parts 38 arranged at regular intervals in the front-rear direction. As shown in FIG. 11, in the present embodiment, the pressure adjustment mechanism 33 disposed on the rightmost side includes four ink inflow parts 38. Moreover, the remaining three pressure adjustment mechanisms 33 include two ink inflow parts 38. That is, the head unit 4 includes a total of ten ink inflow parts 38. In the three pressure adjustment mechanisms 33 having two ink inflow parts 38, the two ink inflow parts 38 are disposed at positions in the front half of the pressure adjustment mechanism 33. Among the four or two ink inflow parts 38 that the four pressure adjustment mechanisms 33 have, the ink inflow part 38 disposed at the frontmost position is disposed at the same position in the front-rear direction, and the ink inflow part 38 disposed second from the front is disposed at the same position in the front-rear direction.

The circuit board 34 is a rigid board such as a glass epoxy board and the like. The circuit board 34 is formed in a rectangular flat plate shape. The circuit board 34 is fixed to the unit side cover 37 so that the thickness direction of the circuit board 34 and the front-rear direction coincide. The circuit board 34 is disposed on the front side of the unit frame 36. All of the heads 3 included in the head unit 4 are electrically connected to the circuit board 34. In the present embodiment, one head 3 is electrically connected to the circuit board 34.

The head 3 is connected to the circuit board 34 via wiring such as FFC (Flexible Flat Cable). Moreover, a heater and thermistor and the like that constitute part of the ink heating mechanism are also electrically connected to the circuit board 34 via wiring. The circuit board 34 fulfills the function as a relay board. For example, in the case where the head unit 4 has four heads 3, all of the four heads 3 are electrically connected to the circuit board 34.

One connector 35 is mounted on the circuit board 34. The connector 35 is mounted on the front surface of the circuit board 34. Moreover, the connector 35 is mounted on the upper end of the circuit board 34. A connector 45 to be described later that the opening-closing unit 12 has is inserted and connected to the connector 35 from the upper side. The connector 35 of the present embodiment is a floating connector having a floating mechanism. In the connector 35, the portion into which the connector 45 is inserted is rotatable relative to the circuit board 34 with the left-right direction as the axial direction of rotation. The unit side cover 37 is fixed to the front end portion of the unit frame 36. The unit side cover 37 covers the circuit board 34 from both sides and front side in the left-right direction.

### Configuration of Opening-Closing Unit

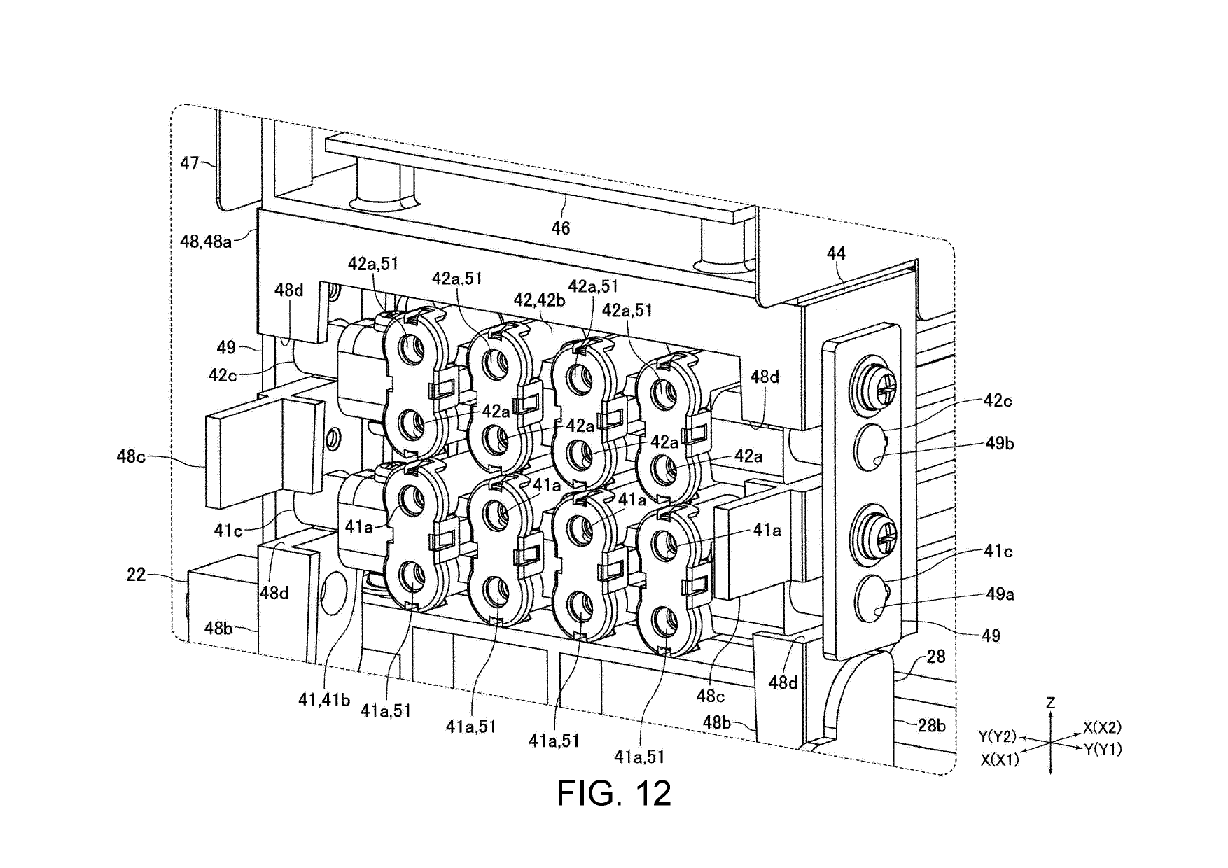

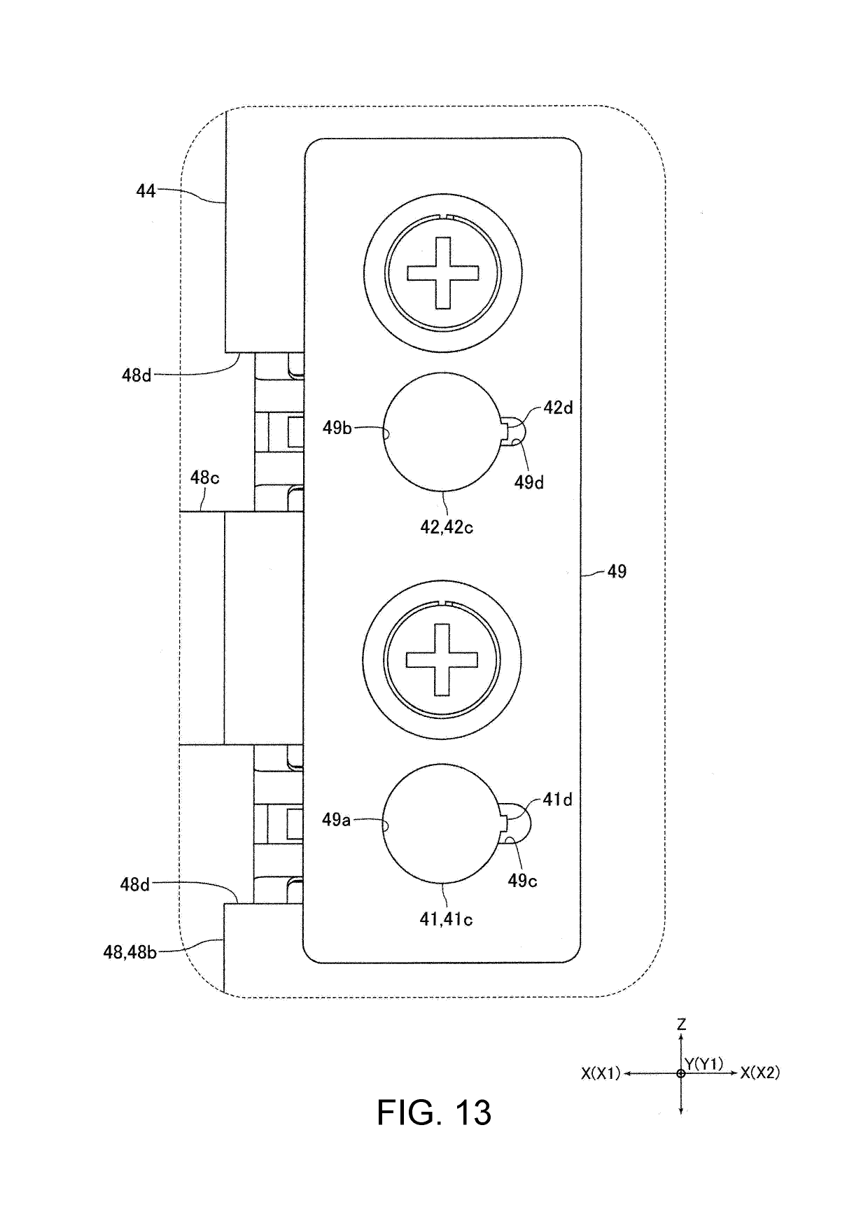

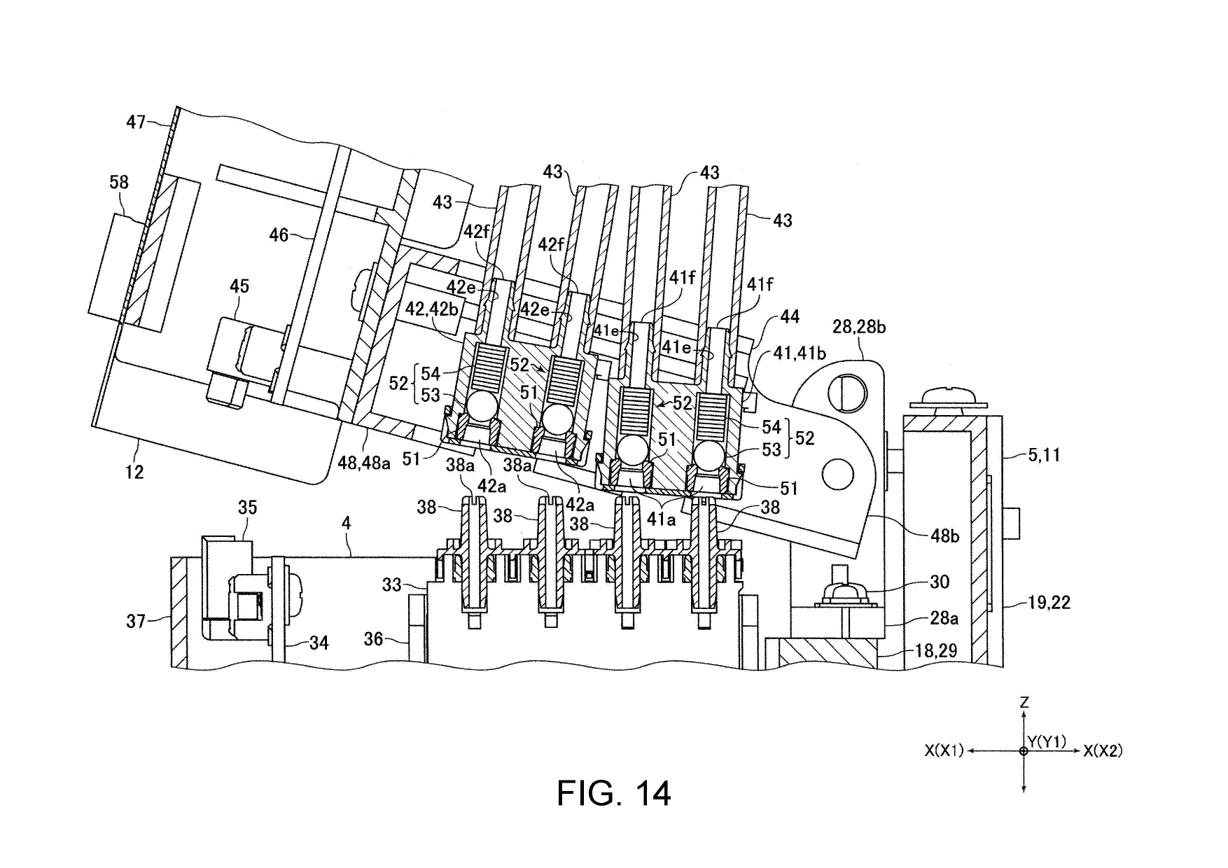

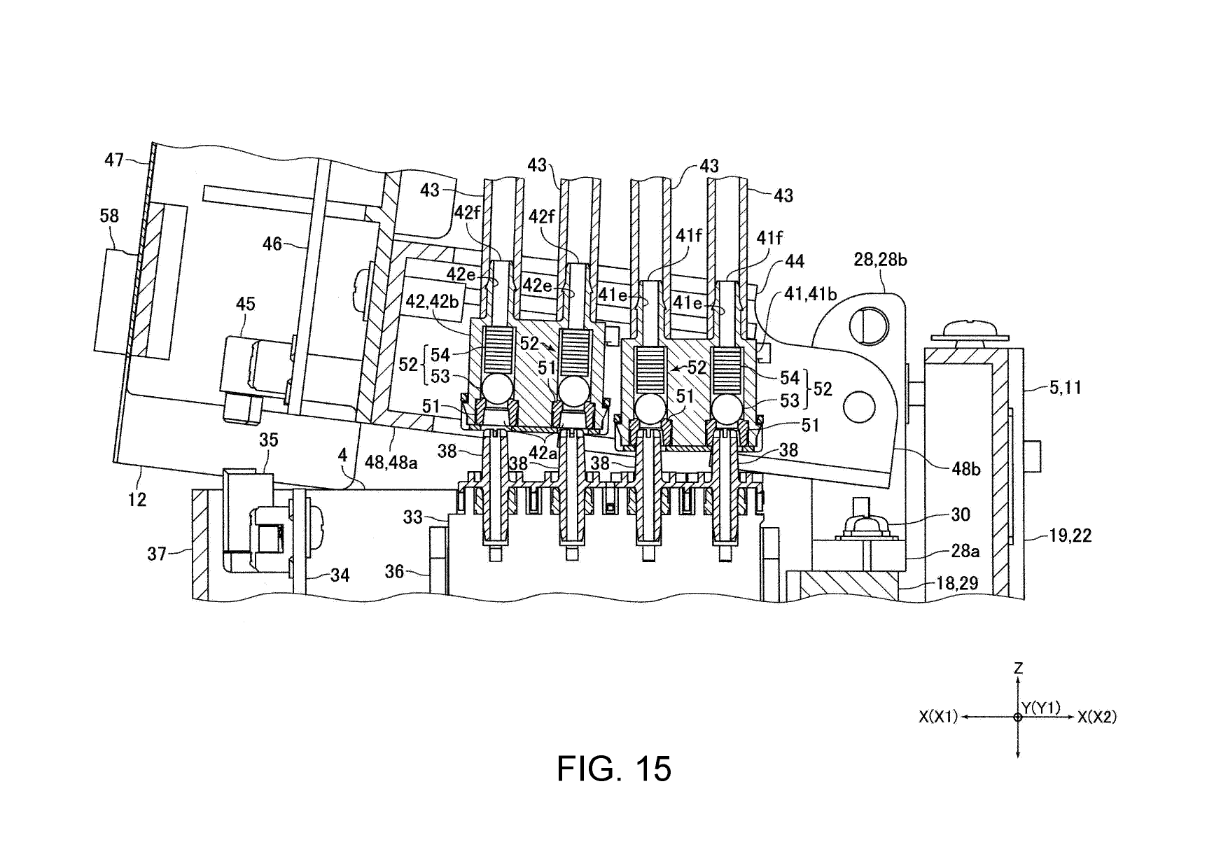

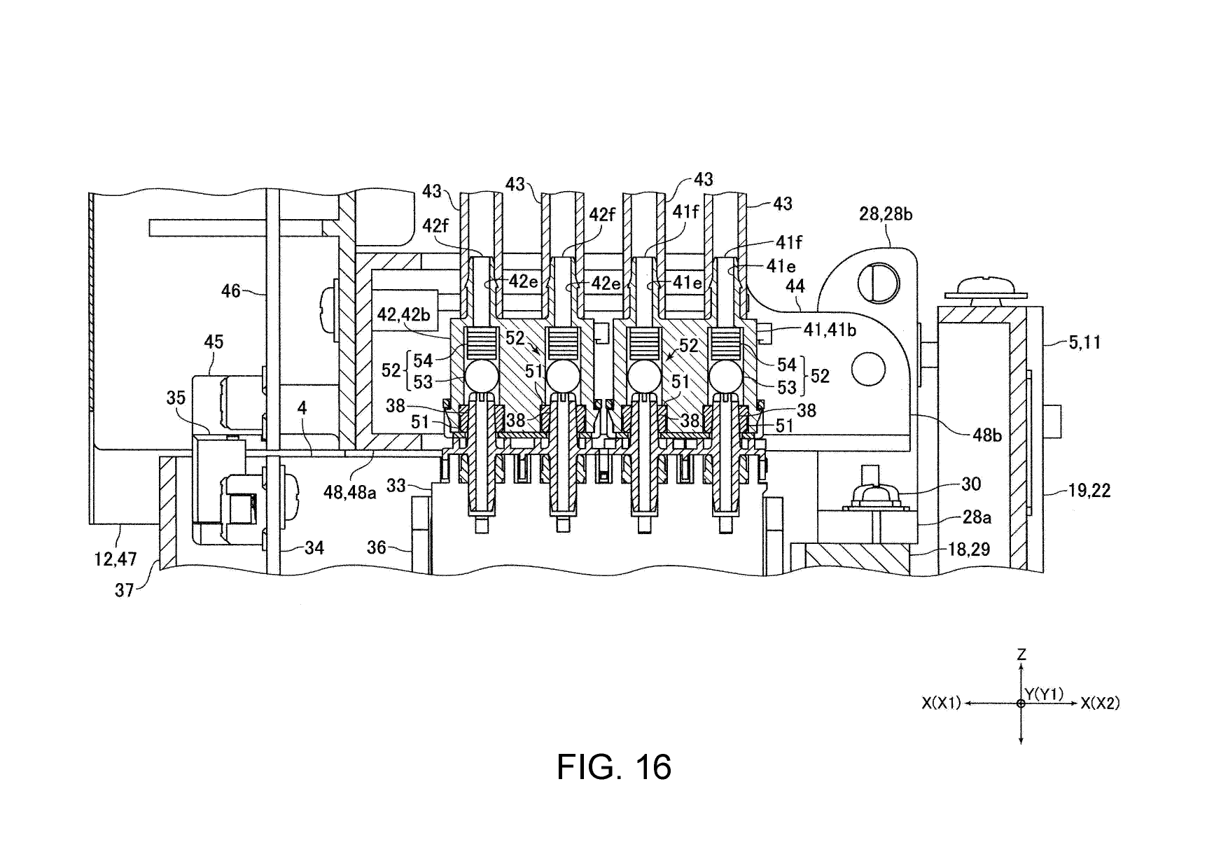

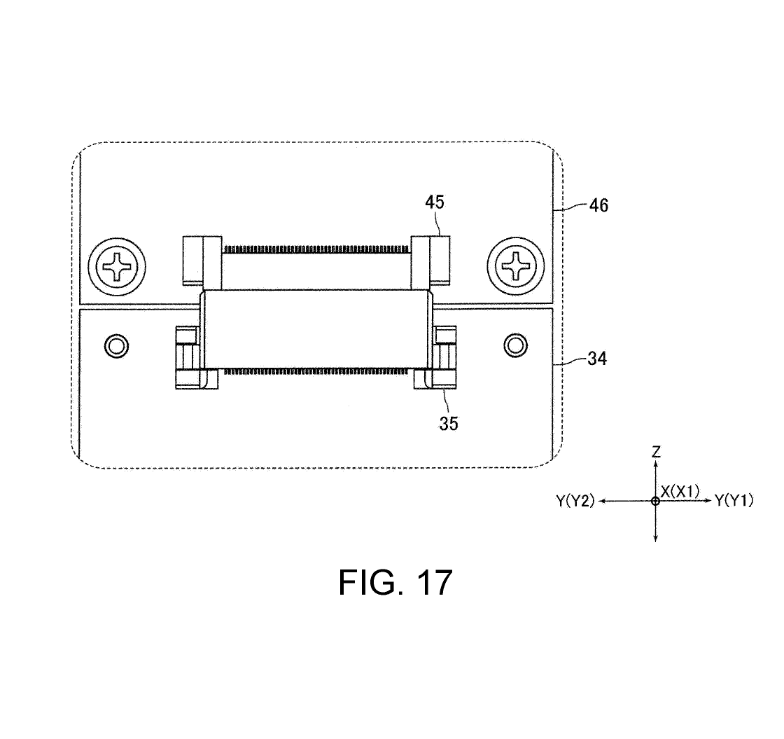

FIG. 12 is an enlarged view of part E in FIG. 4. FIG. 13 is an enlarged side view illustrating the connection parts 41, 42 and a unit frame 44 from the F-F direction in FIG. 7. FIGS. 14 and 15 are cross-sectional views illustrating a state before the ink inflow part 38 and the connection parts 41, 42 shown in FIG. 11 are connected. FIG. 16 is a cross-sectional view illustrating a state in which the ink inflow part 38 and the connection parts 41, 42 shown in FIG. 11 are connected. FIG. 17 is an enlarged front view illustrating a connecting portion between the connector 35 and the connector 45 from the G-G direction in FIG. 6.

The opening-closing unit 12 includes connection parts 41, 42 in which ink outlets (ports) 41a, 42a are formed and which are connectable to the ink inflow part 38. That is, the carriage 5 includes connection parts 41, 42 connectable to a plurality of ink inflow parts 38. The opening-closing unit 12 of the present embodiment includes two connection parts: connection parts 41, 42. The connection parts 41, 42 are connected to the ink tank 8. Specifically, the connection parts 41, 42 are connected to the ink tank 8 via a plurality of tubes 43, and ink is supplied from the ink tank 8 to the connection parts 41, 42. The ink tank 8 is disposed above the connection parts 41, 42, and ink is supplied from the ink tank 8 to the connection parts 41, 42 by head difference.

Moreover, the opening-closing unit 12 includes a unit frame 44 that rotatably holds the connection parts 41, 42, a connector 45 connectable to the connector 35, a circuit board 46 on which the connector 45 is mounted, and an unit side cover 47 fixed to the unit frame 44. The connector 45 of the present embodiment is a carriage side connector, and the circuit board 46 is a carriage side circuit board.

As described above, the opening-closing unit 12 is rotatably attached to the carriage main body 11. Specifically, the unit frame 44 is rotatably attached to the carriage main body 11. The unit frame 44 is connected to the rear upper end of the carriage main body 11. Specifically, the rear end of the unit frame 44 when the opening-closing unit 12 is disposed at a close position 12A to be described later is connected to the support unit 28b of the holding member 28. In the present embodiment, the rear end of the unit frame 44 when the opening-closing unit 12 is disposed at the close position 12A constitutes the rear end of the opening-closing unit 12, and the rear end of the opening-closing unit 12 when the opening-closing unit 12 is disposed at the close position 12A is connected to the rear upper end of the carriage main body 11. The unit frame 44 is rotatable relative to the carriage main body 11 with the left-right direction as the axial direction of rotation. The left-right direction (Y direction) of the present embodiment is a first direction that is the axial direction of rotation of the unit frame 44 relative to the carriage main body 11.

The opening-closing unit 12 is rotatable relative to the carriage main body 11 between the close position 12A (see FIG. 3) in which the ink inflow part 38 and the connection parts 41, 42 are connected to enable ink inflow from the connection parts 41, 42 to the ink inflow part 38, and an open position 12B (see FIG. 4) in which the ink inflow part 38 and the connection parts 41, 42 are separated to disable ink inflow from the connection parts 41, 42 to the ink inflow part 38. That is, the opening-closing unit 12 is rotatable relative to the carriage main body 11 between the close position 12A in which ink supply from the ink tank 8 to the head unit 4 is enabled, and the open position 12B in which ink supply from the ink tank 8 to the head unit 4 is blocked. During printing of the printing medium 2, the opening-closing unit 12 is disposed at the close position 12A.

In the present embodiment, in response to the opening-closing unit 12 being disposed at the close position 12A, all ink inflow parts 38 (that is, ten ink inflow parts 38) included in the head unit 4 are connected to the connection parts 41, 42, enabling ink inflow from the connection parts 41, 42 to all ink inflow parts 38. Moreover, in response to the opening-closing unit 12 being disposed at the open position 12B, all ink inflow parts 38 are separated from the connection parts 41, 42, disabling ink inflow from the connection parts 41, 42 to all of the ink inflow parts 38.

Moreover, in the present embodiment, in response to the opening-closing unit 12 being disposed at the close position 12A, the ink inflow parts 38 formed in a tubular shape are inserted into the outlets 41a, 42a. Specifically, as will be described later, a plurality of outlets 41a, 42a are formed in the connection parts 41, 42, and in response to the opening-closing unit 12 being disposed at the close position 12A, all ink inflow parts 38 included in the head unit 4 are inserted into the outlets 41a, 42a.

When the opening-closing unit 12 is disposed at the open position 12B, the opening-closing unit 12 is disposed on the upper side of the opening-closing unit retaining part 18 and the carriage back part 22. Moreover, when the opening-closing unit 12 is disposed at the open position 12B, the opening-closing unit 12 is disposed above the head unit 4 mounted on the head unit mounting part 17. When the opening-closing unit 12 is disposed at the open position 12B, the head unit 4 may be attached to and detached from the carriage main body 11.

In response to the opening-closing unit 12 disposed at the open position 12B (that is, the opening-closing unit 12 disposed above the opening-closing unit retaining part 18 and the carriage back part 22) rotating 90° so as to fall forward with the lower end portion of the opening-closing unit 12 as the rotating center and with the left-right direction as the axial direction of rotation, the opening-closing unit 12 is disposed at the close position 12A. When the opening-closing unit 12 is disposed at the close position 12A, the connection parts 41, 42 are connected to the ink inflow part 38 from the upper side. The opening-closing unit 12 disposed at the close position 12A covers the head unit 4 from the upper side.

The unit frame 44 includes a frame main body 48 and a regulating component 49 for regulating the rotation range of the connection parts 41, 42 relative to the unit frame 44. The unit frame 44 of the present embodiment includes two regulating components 49. The frame main body 48 includes a first frame part 48a that constitutes a front portion of the frame main body 48 when the opening-closing unit 12 is disposed at the close position 12A. The first frame part 48a is formed in a hollow rectangular parallelepiped-shape elongated in the left-right direction. The first frame part 48a constitutes an upper portion of the frame main body 48 when the opening-closing unit 12 is disposed at the open position 12B.

Moreover, when the opening-closing unit 12 is disposed at the close position 12A, the frame main body 48 includes two second frame parts 48b that extend rearward from both ends of the first frame part 48a in the left-right direction, and guide parts 48c that extend downward from intermediate positions in the front-rear direction of each of the two second frame parts 48b. The left-right direction outer side surfaces of the two second frame parts 48b are planes orthogonal to the left-right direction. The rear ends of the second frame parts 48b when the opening-closing unit 12 is disposed at the close position 12A are connected to the support units 28b of the holding member 28.

The second frame part 48b is formed with two notch parts 48d in which shaft parts 41c, 42c to be described later that constitute a part of the connection parts 41, 42 are disposed. The notch part 48d is cut out toward the upper side from the lower surface of the second frame part 48b when the opening-closing unit 12 is disposed at the close position 12A. The guide part 48c is formed in a flat plate shape with the left-right direction as the thickness direction. The guide part 48c is formed between the two notch parts 48d. When the opening-closing unit 12 is disposed at the close position 12A, the two guide parts 48c are disposed outside the left-right direction side surfaces of the unit frame 36 of the head unit 4. The guide part 48c fulfills a function of guiding the opening-closing unit 12 relative to the head unit 4 when the opening-closing unit 12 rotates from the open position 12B to the close position 12A.

The regulating component 49 is formed in a rectangular flat plate shape. One regulating component 49 of the two regulating components 49 is fixed to the right side surface of the second frame part 48b disposed on the right side, and the other regulating component 49 is fixed to the left side surface of the second frame part 48b disposed on the left side. The thickness direction of the regulating component 49 coincides with the left-right direction. The regulating component 49 is formed with two insertion ports 49a, 49b into which the shaft parts 41c, 42c to be described later that constitute a part of the connection parts 41, 42 are inserted. The insertion ports 49a, 49b are round holes that penetrate the regulating component 49 in the left-right direction.

The connection parts 41, 42 are formed of resin. The connection part 41 and the connection part 42 are formed in the same shape. The connection parts 41, 42 are rotatable relative to the unit frame 44 with the left-right direction as the axial direction of rotation. The two connection parts 41, 42 are disposed on the rear side of the first frame part 48a when of the opening-closing unit 12 is disposed at the close position 12A. Moreover, the two connection parts 41, 42 are disposed adjacent to each other in the front-rear direction when the opening-closing unit 12 is disposed at the close position 12A. In the present embodiment, when the opening-closing unit 12 is disposed at the close position 12A, the connection part 41 is disposed on the rear side of the connection part 42, and the connection part 41 is disposed at a position closer to the rotational center of the unit frame 44 with respect to the carriage main body 11 than the connection part 42.

The connection parts 41, 42 include an annular seal member 51 that comes into contact with the outer peripheral surface of the ink inflow part 38 inserted into the outlets 41a, 42a with a predetermined contact pressure, and a check valve 52 that prevents ink leakage from the outlets 41a, 42a when the ink inflow part 38 and the connection parts 41, 42 are separated. The connection part 41 includes a rectangular parallelepiped-shape base part 41b in which a plurality of outlets 41a are formed. The connection part 42 includes a rectangular parallelepiped-shape base part 42b in which a plurality of outlets 42a are formed. That is, a plurality of outlets 41a, 42a are formed in the connection parts 41, 42.

The base parts 41b, 42b are disposed between the two second frame parts 48b in the left-right direction. Moreover, the connection part 41 includes two shaft parts 41c that constitute the ends of the connection part 41 in the left-right direction, and the connection part 42 includes two shaft parts 42c that constitute the ends of the connection part 42 in the left-right direction. The shaft parts 41c, 42c are formed in a columnar shape with the left-right direction as the axial direction. The shaft part 41c protrudes from the base part 41b toward both sides in the left-right direction, and the shaft part 42c protrudes from the base part 42b toward the outside in the left-right direction.

As shown in FIG. 13, the shaft part 41c is formed with a regulation protrusion 41d that protrudes from the outer peripheral surface of the shaft part 41c toward the radially outer side of the shaft part 41c, and the shaft part 42c is formed with a regulation protrusion 42d that protrudes from the outer peripheral surface of the shaft part 42c toward the radially outer side of the shaft part 42c. That is, the connection parts 41, 42 include the regulation protrusions 41d, 42d. The shaft part 41c is inserted into the insertion port 49a of the regulating component 49 and is rotatably held by the regulating component 49. The shaft part 42c is inserted into the insertion port 49b of the regulating component 49 and is rotatably held by the regulating component 49. The connection part 41 is rotatable relative to the unit frame 44 with the shaft part 41c as the rotational center. The connection part 42 is rotatable relative to the unit frame 44 with the shaft part 42c as the rotational center.

The regulating component 49 is formed with a regulation concave part 49c in which the regulation protrusion 41d is disposed, and a regulation concave part 49d in which the regulation protrusion 42d is disposed. The regulation concave part 49c is recessed from the inner peripheral surface of the insertion port 49a toward the radially outer side of the insertion port 49a, and the regulation concave part 49d is recessed from the inner peripheral surface of the insertion port 49b toward the radially outer side of the insertion port 49b. In the present embodiment, the rotation range of the connection part 41 relative to the unit frame 44 is regulated by the regulation protrusion 41d and the regulation concave part 49c, and the rotation range of the connection part 42 relative to the unit frame 44 is regulated by the regulation protrusion 42d and the regulation concave part 49d.

That is, the regulating component 49 regulates the rotation range of each of the two connection parts 41, 42 relative to the unit frame 44. As shown in FIG. 13, the width of the regulation concave part 49c in the circumferential direction of the insertion port 49a is wider than the width of the regulation concave part 49d in the circumferential direction of the insertion port 49b. Therefore, the rotatable range of the connection part 41 relative to the unit frame 44 is wider than the rotatable range of the connection part 42 relative to the unit frame 44.

Eight outlets 41a are formed in the base part 41b, and eight outlets 42a are formed in the base part 42b. In the base part 41b, four outlets 41a are arranged in the left-right direction at a constant pitch, and the four outlets 41a arranged in the left-right direction are arranged in two rows in the front-rear direction when the opening-closing unit 12 is disposed at the close position 12A. Similarly, in the base part 42b, four outlets 42a are arranged in the left-right direction at a constant pitch, and the four outlets 42a arranged in the left-right direction are arranged in two rows in the front-rear direction when the opening-closing unit 12 is disposed at the close position 12A.

When the opening-closing unit 12 is disposed at the close position 12A, the base part 42b is connected to the ink inflow part 38 disposed at the frontmost position among the four or two ink inflow parts 38 included in the four pressure adjustment mechanisms 33, and the ink inflow part 38 disposed second from the front. That is, when the opening-closing unit 12 is disposed at the close position 12A, the ink inflow parts 38 are inserted into all of the eight outlets 42a. On the other hand, when the opening-closing unit 12 is disposed at the close position 12A, the base part 41b is connected to the ink inflow part 38 disposed at the rearmost position of the pressure adjustment mechanism 33 disposed at the rightmost position, and the ink inflow part 38 disposed second from the rear. That is, when the opening-closing unit 12 is disposed at the close position 12A, the ink inflow parts 38 are inserted into two outlets 41a.

The base part 41b is formed with an ink flow paths 41e leading to the outlets 41a, and the base part 42b is formed with an ink flow path 42e leading to the outlets 42a. That is, eight flow paths 41e are formed in the base part 41b, and eight flow paths 42e are formed in the base part 42b. The base part 41b includes a cylindrical tube connection part 41f to which the tube 43 may be connected. The base part 42b includes a cylindrical tube connection part 42f to which the tube 43 may be connected. The flow paths 41e, 42e of the present embodiment are connection part ink flow paths.

The inner peripheral side of the tube connection part 41f constitutes a part of the flow path 41e, and the base part 41b includes eight tube connection parts 41f. Similarly, the inner peripheral side of the tube connection part 42f constitutes a part of the flow path 42e, and the base part 42b includes eight tube connection parts 42f. In the base part 42b, the tubes 43 are connected to all of the eight tube connection parts 42f. On the other hand, in the base part 41b, the tubes 43 are connected only to two tube connection parts 41f corresponding to two outlets 41a into which the ink inflow parts 38 are inserted.

The seal member 51 is a rubber packing. The seal member 51 is disposed at the outlets 41a, 42a, and fulfills a function of preventing ink from leaking between the connection parts 41, 42 and the ink inflow parts 38. The check valve 52 includes a sphere 53 disposed in the flow paths 41e, 42e, and a compression coil spring 54 as a spring member that biases the sphere 53 toward the seal member 51. The compression coil spring 54 is disposed in the flow paths 41e, 42e. The check valve 52 fulfills a function of preventing ink leakage from each of the plurality of outlets 41a, 42a.

In a state where the ink inflow parts 38 are not inserted into the outlets 41a, 42a, the sphere 53 comes into contact with the seal member 51 with a predetermined contact pressure due to the biasing force of the compression coil spring 54, and ink leakage from the outlets 41a, 42a is prevented (see FIGS. 14 and 15). In response to the ink inflow parts 38 being inserted into the outlets 41a, 42a, the sphere 53 is pushed toward the inner side of the flow paths 41e, 42e by the ink inflow parts 38, and the sphere 53 separates from the seal member 51 (see FIG. 16). In response to the sphere 53 separating from the seal member 51, ink inflow from the connection parts 41, 42 to the ink inflow parts 38 becomes possible.

The circuit board 46 is a rigid board such as a glass epoxy board and the like. The circuit board 46 is formed in a rectangular flat plate shape. When the opening-closing unit 12 is disposed at the close position 12A, the thickness direction of the circuit board 46 coincides with the front-rear direction. The circuit board 46 is disposed on the front side of the unit frame 44 when the opening-closing unit 12 is disposed at the close position 12A. A control circuit for controlling the head unit 4 is mounted on the circuit board 46. The circuit board 46 is electrically connected to the main body side of the printer 1 via wiring such as FFC. One connector 45 is mounted on the circuit board 46. The connector 45 is mounted on the front surface of the circuit board 46 when the opening-closing unit 12 is disposed at the close position 12A, and is mounted at the lower end portion of the circuit board 46.

In the present embodiment, in response to the opening-closing unit 12 being disposed at the close position 12A, the connector 35 and the connector 45 are connected (see FIGS. 16 and 17). Moreover, in response to the opening-closing unit 12 being disposed at the open position 12B, the connector 35 and the connector 45 are separated. That is, the opening-closing unit 12 is rotatable relative to the carriage main body 11 between the close position 12A where the connector 35 and the connector 45 are connected and the open position 12B where the connector 35 and the connector 45 are separated.

The unit side cover 47 covers the circuit board 46 from both sides and front side in the left-right direction when the opening-closing unit 12 is disposed at the close position 12A. A part of the unit side cover 47 constitutes the front surface of the opening-closing unit 12 when the opening-closing unit 12 is disposed at the close position 12A. The unit side cover 47 is formed with a notch part 47a for disposing a receiving member 58, which will be described later, that constitutes a part of the fixture 14. The notch part 47a is cut out from the lower end portion of the unit side cover 47 toward the upper side when the opening-closing unit 12 is disposed at the close position 12A.

### Configuration of Fixture

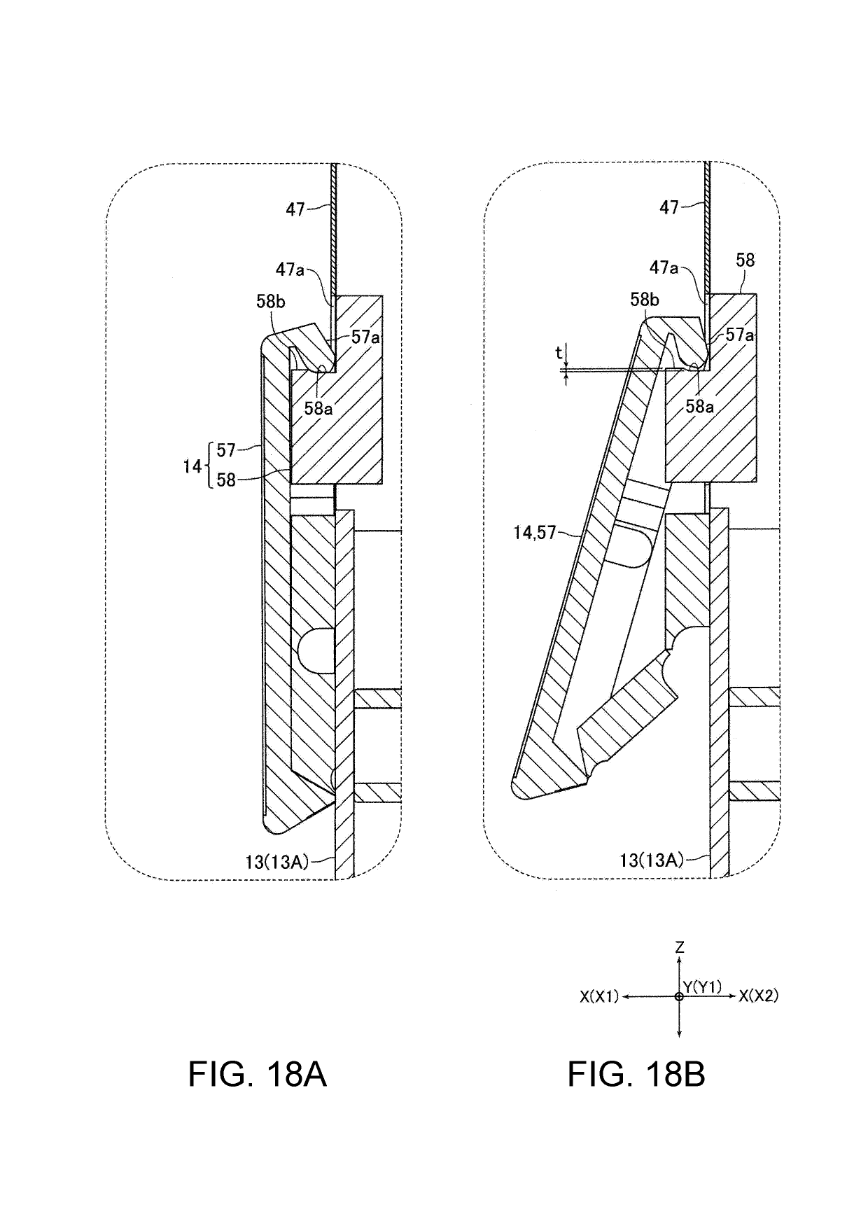

FIGS. 18A and 18B are enlarged cross-sectional views of the fixture 14 shown in FIG. 3.

The fixture 14 is a draw latch that includes a hanging member 57 attached to the main body side cover 13 and the receiving member 58 fixed to the unit side cover 47. For example, the fixture 14 is a draw latch that is a slight improvement of the product “Draw Catch” specified by model number “TL-241” manufactured by Tochigiya Co., Ltd. In the following description, the fixture 14 is referred to as “draw latch 14”. The hanging member 57 is attached to the upper end of the front surface of the main body side cover 13 disposed at the standing position 13A. Moreover, the hanging member 57 is attached to the center of the main body side cover 13 in the left-right direction. The hanging member 57 is disposed on the front side of a rotational center C1 (see FIG. 5) of the main body side cover 13 relative to the carriage main body 11.

The receiving member 58 is attached to the lower end portion of the front surface of the unit side cover 47 when the opening-closing unit 12 is disposed at the close position 12A. A part of the receiving member 58 is disposed in the notch part 47a. As shown in FIGS. 18A and 18B, the receiving member 58 is formed with a contact surface 58a where an engagement part 57a of the hanging member 57 comes into contact from the upper side with a predetermined contact pressure. On the front side of the contact surface 58a when the opening-closing unit 12 is disposed at the close position 12A, a convex part 58b for hooking the engagement part 57a is formed. A protrusion amount t (see FIGS. 18A and 18B) of the convex part 58b relative to the contact surface 58a is, for example, approximately 0.3 (mm). Note that in FIG. 16, the illustration of the receiving member 58 is omitted. Moreover, the convex part 58b may not need to be formed on the receiving member 58.

In the present embodiment, as shown in FIG. 18A, in response to the draw latch 14 being in a locked state and the main body side cover 13 and the unit side cover 47 being fixed to each other, the opening-closing unit 12 is held at the close position 12A. That is, the draw latch 14 fulfills the function of holding the opening-closing unit 12 disposed at the close position 12A at the close position 12A by fixing the opening-closing unit 12 disposed at the close position 12A and the main body side cover 13 disposed at the standing position 13A to each other.

As described above, the hanging member 57 is disposed on the front side of the rotational center C1 of the main body side cover 13 relative to the carriage main body 11. Moreover, the hanging member 57 is disposed above the rotational center C1. Moreover, the protrusion amount t of the convex part 58b relative to the contact surface 58a is, for example, approximately 0.3 (mm), which is very small. Therefore, in the present embodiment, for example, as shown in FIG. 18B, even if the engagement part 57a of the hanging member 57 is hooked on the convex part 58b of the receiving member 58, if the draw latch 14 is not in a locked state, the main body side cover 13 disposed at the standing position 13A falls to the opening position 13B.

### Replacement Operation of Head Unit

When replacing the head unit 4 mounted on the carriage main body 11, first, after the hanging member 57 is removed from the receiving member 58, the opening-closing unit 12 is rotated from the close position 12A to the open position 12B. In response to the opening-closing unit 12 being rotated from the close position 12A to the open position 12B, all the ink inflow parts 38 and the connection parts 41, 42 are separated, and the connector 35 and the connector 45 are separated. In this state, the head unit 4 to be replaced is removed from the carriage main body 11.

After that, after the new head unit 4 is mounted on the head unit mounting part 17, the opening-closing unit 12 is rotated from the open position 12B to the close position 12A. In response to the opening-closing unit 12 being rotated to the close position 12A, all the ink inflow parts 38 and the connection parts 41, 42 are connected. In the process of rotating the opening-closing unit 12 from the open position 12B to the close position 12A, first, the ink inflow part 38 and the connection part 41 are connected (see FIG. 14), and thereafter, the ink inflow part 38 and the connection part 42 are connected (see FIG. 15). Moreover, in response to the opening-closing unit 12 being rotated to the close position 12A, the connector 35 and the connector 45 are connected. Moreover, after the opening-closing unit 12 is rotated to the close position 12A, the draw latch 14 is set to a locked state.

In the present embodiment, after the new head unit 4 is mounted on the head unit mounting part 17, the opening-closing unit 12 is rotated from the open position 12B to the close position 12A, and then the draw latch 14 is set to a locked state. Through such a series of simple operations, the connection of the ink supply path between the opening-closing unit 12 and the head unit 4, the electrical connection between the opening-closing unit 12 and the head unit 4, and the fixing of the head unit 4 to the carriage 5 in a state where the head 3 is disposed at a correct position are completed.

### Main Effects of the Present Embodiment

As described above, in the present embodiment, the opening-closing unit 12 includes the connection parts 41, 42 in which the plurality of outlets 41a, 42a are formed and which are connectable to the plurality of ink inflow parts 38 of the head unit 4. Therefore, in the present embodiment, when removing the head 3 attached to the carriage 5 together with the head unit 4, it is possible to separate the plurality of ink inflow parts 38 and the connection parts 41, 42 at once. Moreover, in the present embodiment, when attaching the head 3 to the carriage 5 together with the head unit 4, it is possible to connect the plurality of ink inflow parts 38 and the connection parts 41, 42 at once. That is, in the present embodiment, during replacement of the head 3, it is possible to connect or separate the plurality of ink inflow parts 38 on the head unit 4 side and the connection parts 41, 42 on the carriage 5 side at once. Therefore, in the present embodiment, it is possible to easily perform the replacement operation of the head 3.

Moreover, in the present embodiment, the connection parts 41, 42 include the check valve 52 that prevents ink leakage from each of the plurality of outlets 41a, 42a when the ink inflow parts 38 and the connection parts 41, 42 are separated. Therefore, in the present embodiment, when removing the head 3 attached to the carriage 5 together with the head unit 4, it is possible to prevent the ink remaining in the connection parts 41, 42 from leaking from the outlets 41a, 42a. Therefore, in the present embodiment, it is possible to perform the replacement operation of the head 3 without concern about ink leakage from the outlets 41a, 42a. As a result, in the present embodiment, it is possible to perform the replacement operation of the head 3 more easily.

In the present embodiment, the carriage 5 to which the head unit 4 is detachably attached includes the carriage main body 11 on which the head unit 4 is mounted, and the opening-closing unit 12 rotatably attached to the carriage main body 11. Moreover, in the present embodiment, the opening-closing unit 12 is rotatable relative to the carriage main body 11 between the close position 12A where all the ink inflow parts 38 and the connection parts 41, 42 are connected and ink inflow from the connection parts 41, 42 to all the ink inflow parts 38 becomes possible, and the open position 12B where all the ink inflow parts 38 and the connection parts 41, 42 are separated and ink inflow from the connection parts 41, 42 to all the ink inflow parts 38 becomes impossible.

Therefore, in the present embodiment, when removing the head 3 attached to the carriage 5 together with the head unit 4, by rotating the opening-closing unit 12 disposed at the close position 12A to the open position 12B, it is possible to separate the ink inflow parts 38 and the connection parts 41, 42 so that ink inflow from the connection parts 41, 42 to the ink inflow parts 38 becomes impossible. Moreover, in the present embodiment, when attaching the head 3 together with the head unit 4 to the carriage 5, by rotating the opening-closing unit 12 to the close position 12A in a state where the head unit 4 is mounted on the carriage main body 11, it is possible to connect the ink inflow parts 38 and the connection parts 41, 42 so that ink inflow from the connection parts 41, 42 to the ink inflow parts 38 becomes possible. That is, in the present embodiment, it is possible to connect or separate the ink path on the carriage 5 side and the ink path on the head unit 4 side simply by rotating the opening-closing unit 12 during replacement of the head 3. Therefore, in the present embodiment, it is possible to perform the replacement operation of the head 3 more easily.

In the present embodiment, the check valve 52 includes the sphere 53 disposed in the flow paths 41e, 42e, and the compression coil spring 54 that biases the sphere 53 toward the seal member 51. Therefore, in the present embodiment, with a relatively simple configuration, it is possible to prevent the ink remaining in the connection parts 41, 42 from leaking from the outlets 41a, 42a.

In the present embodiment, the opening-closing unit 12 is attached to the upper end of the carriage main body 11 and is rotatable relative to the carriage main body 11 with the left-right direction as the axial direction of rotation. Therefore, in the present embodiment, an operator performing the replacement operation of the head 3 can rotate the opening-closing unit 12 relative to the carriage main body 11 on the upper side of the carriage 5. Therefore, in the present embodiment, it is possible to easily perform the rotation operation of the opening-closing unit 12 relative to the carriage main body 11.

In the present embodiment, the connection parts 41, 42 are rotatable relative to the unit frame 44 with the left-right direction as the axial direction of rotation. Therefore, the present embodiment, even in the case of inserting a plurality of ink inflow parts 38 into the outlets 41a, 42a of the connection parts 41, 42 by rotating the opening-closing unit 12 relative to the carriage main body 11 with the left-right direction as the axial direction of rotation, it is possible to rotate the connection parts 41, 42 relative to the unit frame 44 and orient the connection parts 41, 42 in a direction that facilitates insertion of the ink inflow parts 38 into the outlets 41a, 42a. Therefore, in the present embodiment, it is possible to easily perform connection between the ink inflow parts 38 and the connection parts 41, 42.

In the present embodiment, the rotation range of the connection parts 41, 42 relative to the unit frame 44 is regulated by the regulation protrusions 41d, 42d formed on the connection parts 41, 42 and the regulation concave parts 49c, 49d formed on the regulating component 49. Therefore, in the present embodiment, even if the connection parts 41, 42 are rotatable relative to the unit frame 44, it is possible to prevent the connection parts 41, 42 from excessively rotating relative to the unit frame 44.

### Other Embodiments

The above-described embodiment is one example of a preferred embodiment of the disclosure, but is not limited thereto, and various modifications may be implemented within the scope that does not change the gist of the disclosure.

In the above-described embodiment, the ink inflow part 38 may not need to be formed in a tubular shape. In this case, for example, the connection parts 41, 42 include tubular insertion parts, and these insertion parts are inserted into the inlets 38a of the ink inflow parts 38. Moreover, in the above-described embodiment, the regulation protrusion 41d may be formed on only one shaft part 41c of the two shaft parts 41c, and the regulation protrusion 42d may be formed on only one shaft part 42c of the two shaft parts 42c. In this case, for example, the regulation concave parts 49c, 49d are formed on only one regulating component 49 of the two regulating components 49.

In the above-described embodiment, the rotatable range of the connection part 41 relative to the unit frame 44 and the rotatable range of the connection part 42 relative to the unit frame 44 may be equal. Moreover, in the above-described embodiment, the rotation range of the connection parts 41, 42 relative to the unit frame 44 may not need to be regulated. Moreover, in the above-described embodiment, the connection parts 41, 42 may not need to be rotatable relative to the unit frame 44. Furthermore, in the above-described embodiment, the number of connection parts that the opening-closing unit 12 has may be one, or may be three or more. In the case where the opening-closing unit 12 includes three or more connection parts, the plurality of connection parts are arranged in the front-rear direction when the opening-closing unit 12 is disposed at the close position 12A.

In the above-described embodiment, the connection part 41 is connected to the ink tank 8, but the connection part 41 may be connected to a circulation path for circulating ink supplied to the head 3. In this case, when removing the head 3 attached to the carriage 5 together with the head unit 4, by rotating the opening-closing unit 12 disposed at the close position 12A to the open position 12B, it is possible to disconnect the ink supply path and circulation path between the opening-closing unit 12 and the head unit 4. Moreover, when attaching the head 3 together with the head unit 4 to the carriage 5, by rotating the opening-closing unit 12 to the close position 12A in a state where the head unit 4 is mounted on the carriage main body 11, it is possible to connect the ink supply path and circulation path between the opening-closing unit 12 and the head unit 4.

In the above-described embodiment, the opening-closing unit 12 may be rotatable relative to the carriage main body 11 with, for example, the front-rear direction as the axial direction of rotation. In this case, the front-rear direction serves as the first direction. Moreover, the opening-closing unit 12 may be rotatable relative to the carriage main body 11 with a direction inclined relative to the horizontal direction as the axial direction of rotation. Furthermore, in the above-described embodiment, the opening-closing unit 12 may be attached to a portion other than the upper end of the carriage main body 11. Moreover, in the above-described embodiment, the opening-closing unit 12 may not need to be mechanically connected to the carriage main body 11. In this case, when the head unit 4 is attached to or detached from the carriage main body 11, the opening-closing unit 12 is separated and removed from the carriage main body 11.

In the above-described embodiment, the head unit 4 may not need to include the circuit board 34 and the connector 35. In this case, the opening-closing unit 12 includes, for example, wiring such as FFC connected to the head 3, instead of the circuit board 46 and the connector 45. Moreover, in the above-described embodiment, the head unit 4 may include a sub-tank that contains ink supplied to the head 3, instead of the pressure adjustment mechanism 33. Moreover, in the above-described embodiment, the printer 1 may include a pump that supplies ink from the ink tank 8 to the pressure adjustment mechanism 33. Furthermore, in the above-described embodiment, the printer 1 may include a table on which the printing medium 2 is placed and a table drive mechanism that moves the table in the front-rear direction, instead of the platen 9. Moreover, in the above-described embodiment, the printer 1 may be a three-dimensional (3D) printer that forms three-dimensional objects.

What is claimed is:

1. An inkjet printer, comprising:
a head unit having an inkjet head that discharges ink; a carriage to which the head unit is detachably attached; a carriage drive mechanism that reciprocally moves the carriage in a main scanning direction orthogonal to an up-down direction; and an ink tank that contains ink supplied to the inkjet head,
wherein the head unit includes a plurality of ink inflow parts in which ink inlets are formed,
the carriage includes a connection part that is connected to the ink tank and in which ink outlets are formed, and that is connectable to the plurality of ink inflow parts,
a plurality of the outlets are formed in the connection part, and
the connection part includes a check valve that prevents ink leakage from each of the plurality of outlets in the case of the ink inflow parts and the connection part being separated from each other.

2. The inkjet printer according to claim 1,
wherein the ink inflow part is formed in a tubular shape and is inserted into the outlet,
a connection part ink flow path, which is an ink flow path leading to the outlet, is formed in the connection part,
the connection part includes an annular seal member that comes into contact with an outer peripheral surface of the ink inflow part inserted into the outlet with a predetermined contact pressure, and
the check valve includes a sphere disposed in the connection part ink flow path and a spring member that biases the sphere toward the seal member.

3. The inkjet printer according to claim 1,
wherein the carriage includes a carriage main body on which the head unit is mounted and an opening-closing unit rotatably attached to the carriage main body, and
the opening-closing unit includes the connection part and is rotatable relative to the carriage main body between a close position where all of the ink inflow parts and the connection part are connected to enable ink inflow from the connection part to all of the ink inflow parts, and an open position where all of the ink inflow parts and the connection part are separated to disable ink inflow from the connection part to all of the ink inflow parts.

4. The inkjet printer according to claim 2,
wherein the carriage includes a carriage main body on which the head unit is mounted and an opening-closing unit rotatably attached to the carriage main body, and
the opening-closing unit includes the connection part and is rotatable relative to the carriage main body between a close position where all of the ink inflow parts and the connection part are connected to enable ink inflow from the connection part to all of the ink inflow parts, and an open position where all of the ink inflow parts and the connection part are separated to disable ink inflow from the connection part to all of the ink inflow parts.

5. The inkjet printer according to claim 3,
wherein the opening-closing unit is attached to an upper end of the carriage main body and is rotatable relative to the carriage main body with a horizontal direction as an axial direction of rotation, and
the connection part is connected to the ink inflow part from an upper side.

6. The inkjet printer according to claim 4,
wherein the opening-closing unit is attached to an upper end of the carriage main body and is rotatable relative to the carriage main body with a horizontal direction as an axial direction of rotation, and
the connection part is connected to the ink inflow part from an upper side.

7. The inkjet printer according to claim 5,
wherein the ink inflow part is formed in a tubular shape with the up-down direction as the axial direction,
one of the inlets is formed at an upper end of the ink inflow part, and
all of the ink inflow parts are inserted into the outlets in response to the opening-closing unit being disposed at the close position.

8. The inkjet printer according to claim 6,
wherein the ink inflow part is formed in a tubular shape with the up-down direction as the axial direction,
one of the inlets is formed at an upper end of the ink inflow part, and
all of the ink inflow parts are inserted into the outlets in response to the opening-closing unit being disposed at the close position.

9. The inkjet printer according to claim 7,
wherein the opening-closing unit includes a unit frame that rotatably holds the connection part,
the unit frame is rotatably attached to the carriage main body, and
in response to the axial direction of rotation of the unit frame relative to the carriage main body being taken as a first direction, the connection part is rotatable relative to the unit frame with the first direction as the axial direction of rotation.

10. The inkjet printer according to claim 8,
wherein the opening-closing unit includes a unit frame that rotatably holds the connection part,
the unit frame is rotatably attached to the carriage main body, and
in response to the axial direction of rotation of the unit frame relative to the carriage main body being taken as a first direction, the connection part is rotatable relative to the unit frame with the first direction as the axial direction of rotation.

11. The inkjet printer according to claim 9,
wherein the unit frame includes a regulating component for regulating a rotation range of the connection part relative to the unit frame,
the connection part includes a shaft part that constitutes an end of the connection part in the first direction, and a regulation protrusion that protrudes from the shaft part toward a radially outer side of the shaft part,
the regulating component is formed with an insertion port into which the shaft part is inserted, and a regulation concave part in which the regulation protrusion is disposed, and
the rotation range of the connection part relative to the unit frame is regulated by the regulation protrusion and the regulation concave part.

12. The inkjet printer according to claim 10,
wherein the unit frame includes a regulating component for regulating a rotation range of the connection part relative to the unit frame,
the connection part includes a shaft part that constitutes an end of the connection part in the first direction, and a regulation protrusion that protrudes from the shaft part toward a radially outer side of the shaft part,
the regulating component is formed with an insertion port into which the shaft part is inserted, and a regulation concave part in which the regulation protrusion is disposed, and
the rotation range of the connection part relative to the unit frame is regulated by the regulation protrusion and the regulation concave part.

13. An inkjet printer, comprising:
a head unit having an inkjet head that discharges ink; a carriage to which the head unit is detachably attached; a carriage drive mechanism that reciprocally moves the carriage in a main scanning direction orthogonal to an up-down direction; and an ink tank that contains ink supplied to the inkjet head,
wherein the head unit includes a plurality of ink inflow parts in which ink inlets are formed, and
the carriage includes a connection part that is connected to the ink tank and in which ink outlets are formed, and that is connectable to the plurality of ink inflow parts.

14. The inkjet printer according to claim 13,
wherein the carriage includes a carriage main body on which the head unit is mounted and an opening-closing unit rotatably attached to the carriage main body, and
the opening-closing unit includes the connection part and is rotatable relative to the carriage main body between a close position where all of the ink inflow parts and the connection part are connected to enable ink inflow from the connection part to all of the ink inflow parts, and an open position where all of the ink inflow parts and the connection part are separated to disable ink inflow from the connection part to all of the ink inflow parts.

15. The inkjet printer according to claim 14,
wherein the opening-closing unit is attached to an upper end of the carriage main body and is rotatable relative to the carriage main body with a horizontal direction as an axial direction of rotation, and
the connection part is connected to the ink inflow part from an upper side.

16. The inkjet printer according to claim 15,
wherein the ink inflow part is formed in a tubular shape with the up-down direction as the axial direction,
one of the inlets is formed at an upper end of the ink inflow part, and
all of the ink inflow parts are inserted into the outlets in response to the opening-closing unit being disposed at the close position.

17. The inkjet printer according to claim 16,
wherein the opening-closing unit includes a unit frame that rotatably holds the connection part,
the unit frame is rotatably attached to the carriage main body, and
in response to the axial direction of rotation of the unit frame relative to the carriage main body being taken as a first direction, the connection part is rotatable relative to the unit frame with the first direction as the axial direction of rotation.

18. The inkjet printer according to claim 17,
wherein the unit frame includes a regulating component for regulating a rotation range of the connection part relative to the unit frame,
the connection part includes a shaft part that constitutes an end of the connection part in the first direction, and a regulation protrusion that protrudes from the shaft part toward a radially outer side of the shaft part,
the regulating component is formed with an insertion port into which the shaft part is inserted, and a regulation concave part in which the regulation protrusion is disposed, and
the rotation range of the connection part relative to the unit frame is regulated by the regulation protrusion and the regulation concave part.

19. An inkjet printer, comprising:
a head unit having an inkjet head that discharges ink; a carriage to which the head unit is detachably attached; a carriage drive mechanism that reciprocally moves the carriage in a main scanning direction orthogonal to an up-down direction; and an ink tank that contains ink supplied to the inkjet head,
wherein the head unit includes a plurality of ink inflow parts in which ink inlets are formed, and
the carriage includes a connection part that is connected to the ink tank and in which ink outlets are formed, and that is connectable to the plurality of ink inflow parts,
wherein the carriage includes a carriage main body on which the head unit is mounted and an opening-closing unit rotatably attached to the carriage main body, and
the opening-closing unit includes the connection part and is rotatable relative to the carriage main body between a close position where all of the ink inflow parts and the connection part are connected to enable ink inflow from the connection part to all of the ink inflow parts, and an open position where all of the ink inflow parts and the connection part are separated to disable ink inflow from the connection part to all of the ink inflow parts.

20. The inkjet printer according to claim 19,
wherein the opening-closing unit is attached to an upper end of the carriage main body and is rotatable relative to the carriage main body with a horizontal direction as an axial direction of rotation, and
the connection part is connected to the ink inflow part from an upper side.
